(19) United States
(12) Patent Application Publication
(10) Pub. No.: US 2012/0244334 A1
(43) Pub. Date: Sep. 27, 2012

(54) COMPOSITE COMPRISING AN ELECTRODE-ACTIVE TRANSITION METAL COMPOUND AND A FIBROUS CARBON MATERIAL, AND A METHOD FOR PREPARING THE SAME

(75) Inventors: Sei Ung Park, Daejeon (KR); Dong Suek Lee, Daejeon (KR); Ju Suk Ryu, Daejeon (KR); Seong Jae Lim, Daejeon (KR); Si Jin Oh, Jeollabuk-do (KR)

(73) Assignee: HANWHA CHEMICAL CORPORATION, Seoul (KR)

(21) Appl. No.: 13/393,188

(22) PCT Filed: Dec. 19, 2011
(86) PCT No.: PCT/KR11/09774

§ 371 Date: Feb. 28, 2012

(30) Foreign Application Priority Data
Dec. 22, 2010 (KR) 10-2010-0132466
Apr. 12, 2011 (KR) 10-2011-0033614

(51) Int. Cl. H01B 1/04; B32B 5/02; H01M 4/133; B82Y 40/00; B82Y 30/00

(52) U.S. Cl. 428/221; 252/506; 252/507; 252/508; 252/509; 428/402; 977/762; 977/742; 977/900

(57) ABSTRACT

The present invention provides a complex comprising an aggregate of primary particles of an electrode-active transition metal compound and a fibrous carbon material, wherein said fibrous carbon material is present more densely in the surface region of the aggregate than in the inside of the aggregate.

### TECHNICAL FIELD

The present invention relates to a composite comprising an electrode-active transition metal compound and a fibrous carbon material, and a method for preparing the same.

### BACKGROUND ART

Recent research on energy storage materials has progressed in the direction of either improving output properties of a secondary battery for application to hybrid cars or improving fuel efficiency by utilizing a high power capacitor as an auxiliary output apparatus. Secondary batteries for cars include nickel metal hydride batteries, lithium batteries, etc., and a supercapacitor is a capacitor having specific capacitance improved by 1,000 times or more as compared with conventional capacitive capacitors.

Electrochemical devices such as secondary batteries or supercapacitors utilize, as electrode-active material, transition metal compounds exhibiting electrochemical activity via oxidation-reduction reactions. To allow such electrode-active materials to effectively exhibit their theoretical capacities and voltage properties, it is necessary to control or complement electrochemical properties, such as by increasing electric conductivity, ionic conductivity, etc., and physicochemical properties, such as corrosion resistance, dispersibility, etc. For such purposes, numerous efforts have been made to date.

Examples of such efforts include the nanotization of the particles of transition metal compounds, the solid-solubilization of heteroelements, the formation of a protective film on particle surfaces, the incorporation of electrically conductive materials, etc. Carbon materials or ceramic materials which improve the electric conductivity of electrode materials while having high corrosion resistance and chemical resistance have been frequently used as materials for coating the surfaces of transition metal compound particles.

Particularly, since carbon materials have advantages including high electric conductivity, chemical and physical stability, etc., numerous methods either for mixing or combining carbon materials with transition metal compounds or for coating carbon materials on the surfaces of transition metal compound particles have been proposed to protect the transition metal compounds or improve their functions. Such carbon materials are simply mixed with transition metal compounds via mechanical mixing or coated on the surfaces of transition metal compound particles through chemical vapor deposition. In general, it has been known that coating the surfaces of individual particles with carbon materials is more effective than the mixing of carbon materials in providing surface protection and electric conductivity. The advantages of carbon materials include improved electric conductivity in electrode materials, the protection of transition metal compound particles from external physicochemical influences, the restriction of excessive growth of transition metal compound particles during heat treatment, and the like.

In cases where the surfaces of transition metal compound particles are coated with carbon material, a known method includes applying a carbon-based organic compound as a carbon precursor to the surfaces of particles and then carbonizing the compound via heat treatment under an inert atmosphere. The crystallinity, electric conductivity, mechanical strength, etc. of the resulting carbides are dependent on the kinds of carbon precursors and the atmosphere and temperature of the carbonizing reaction. It is preferable to carry out a carbonizing reaction at a temperature above 1,000° C. in order to achieve full carbonization by completely releasing hydrogen, oxygen, carbohydrates, impurity elements, etc. through thermal decomposition, and to allow the carbides to have high crystallinity. If the temperature of heat treatment is raised, the crystallite size and crystallinity of carbon are increased, and if the crystallinity is increased, the mechanical strength and electric conductivity of the resulting carbides are also increased.

However, if the temperature for carrying out carbonization is raised beyond a certain level, the transition metal compounds may undergo phase transition or pyrolysis. Therefore, the temperature for carbonization should be limited to a range that does not exert an adverse influence on transition metal compounds.

In addition, a carbon coating should have a thickness sufficient to provide physicochemical protection to transition metal compounds, and to ensure a sufficient thickness, carbon precursors should be used in large quantity. However, if carbon precursors are used in large quantity, they may be consumed not only in forming a carbon coating but also in forming carbon by-products, and thus increasing the possibility of causing problems such as decreased electrode density and low dispersibility.

In prior art, carbon coatings were formed by carbonizing carbon precursors at low temperatures, and the coatings were not sufficiently thick. For example, U.S. Pat. Nos. 6,855,273 and 6,962,666 coated the surfaces of electrode material particles with carbon materials and used low temperatures of up to 800° C. for heat treatment for forming a coating. The carbonaceous coatings resulting from carbonization at low temperatures did not have high crystallinity. Further, said prior technique has disadvantages in that it is difficult to completely coat the surfaces of individual particles, and that particles are so fine that they cause a sharp increase of viscosity when dispersed in an organic solvent or a water-based system, thereby lowering dispersibility and lengthening dispersion time, and an excessive amount of a binder is needed for adhesion to an electrode. Moreover, in the case of prior techniques which coat fine primary particles with carbon materials, the bulk density of the resulting product is low, and as a result, electrode density is low. Further, when powdery electrode materials are transported or weighed, the problems of particle scattering and adhesion due to static electricity occur.

In addition, if carbon material is coated on the surfaces of particles, although electric conductivity is improved, the coated carbon material can interfere with the intercalation and deintercalation of ions which accompany electrochemical reactions of transition metal compounds.

As a method which can achieve effects comparable to those of the carbon coating of particles, the utilization of fibrous carbon materials, such as carbon fiber or carbon nanotubes (CNTs) has been proposed. Particularly, a proposal was made to improve electric conductivity by mixing with CNTs.

Korean Patent Application Laying-Open No. 10-2008-0071387 discloses a CNT complex having a structure in which CNTs, electrode materials for a lithium second battery, and carbon material which is formed from the carbonization of polymers are uniformly dispersed. However, this prior art did not disclose a complex of an electrode-active transition metal compound and a fibrous carbon material wherein the fibrous carbon material is present more densely on the surface of the complex than in the inside or in the center of the complex.

### DISCLOSURE

### Technical Problem

The present invention provides an electrode material having good physical and chemical properties, and a method for preparing the same.

### Technical Solution

The present invention provides a complex of an electrode-active transition metal compound and a fibrous carbon material, which comprises an aggregate of primary particles of transition metal compounds and the fibrous carbon materials, and wherein the fibrous carbon materials are present more densely in the surface region of the aggregate than in the inside of the aggregate.

The present invention also provides a method for preparing a complex of a transition metal compound and a fibrous carbon material, which comprises: preparing a mixture wherein a non-functionalized fibrous carbon material, a surface-functionalized fibrous carbon material, and transition metal compound particles are dispersed, and wherein the weight of the surface-functionalized fibrous carbon material is greater than that of the non-functionalized fibrous carbon material; and drying and granulating said mixture.

### ADVANTAGEOUS EFFECTS

The complex according to the present invention comprises an aggregate of primary particles of electrode-active transition metal compounds and fibrous carbon materials, and said fibrous carbon materials are present more densely in the surface region of the aggregate than in the inside thereof, thereby achieving the following effects.

First, the use of a fibrous carbon material having superior electric conductivity enables superior electric conductivity as compared with cases where particles of electrode-active materials are coated with carbon or electrode-active materials are mixed with conventional electric conductive materials.

In the surface region of the complex of the present invention, fibrous carbon materials are present. Different from cases where carbon materials are coated on the surfaces of transition metal compound particles, the fibrous carbon materials in the present invention do not interfere with the intercalation and deintercalation of ions, which accompany electrochemical reactions, and provide sufficient routes for ion movement without disturbing the contact of electrode-active materials with the electrolytic solution, thereby allowing the electrode-active materials to sufficiently exhibit their intrinsic electrochemical properties.

In addition, in the surface region of complexes, the fibrous carbon materials are relatively densely present. Therefore, when preparing an electrode by applying electrode materials to a current collector and rolling them, adjacent complexes are continuously electrically connected by fibrous carbon materials and greatly increase the electric conductivity of the complexes, thereby remarkably increasing high-rate capability. Further, the electrode-active materials can contact the current collector over a larger area due to the medium of the fibrous carbon materials, and thus adhesion increases and the life properties and stability of the electrode are improved.

In addition, the fibrous carbon materials cover the surface region of the complexes and protect the complexes from being dismantled when external forces including compression, shearing, etc. are applied thereto. Further, when preparing electrodes, complexes are made to be in a slurry state to be applied to an electrode plate, and the fibrous carbon materials present on the surface region of the complexes protect the complexes from being dismantled during a dispersion process for making the slurry.

Further, the fibrous carbon materials present in the inside of the complexes electrically connect primary particles and improve the electric conductivity of the complexes. In addition, when the complexes are heat-treated at a high temperature to improve their physical properties in a process for preparing the complexes, the fibrous carbon materials present in the inside of the complexes prevent direct contact among primary particles and inhibit the aggregation or growth of the primary particles.

However, if the fibrous conductive materials are present in an excessive amount in the inside of a complex, the amount of transition metal compounds as a constituent of the complex decreases, and then electrodes produced by utilizing such complexes have problems in that they have a low electrode density and eventually have a low battery capacity and, further, the use of excessive carbon materials increases production costs. In the present invention, since the fibrous carbon materials are present in the inside of complexes at a lower density than in the surface region thereof, said problems do not occur.

Complexes comprising transition metal compounds and fibrous carbon materials according to the present invention are useful as electrode materials for secondary batteries, memory devices, capacitors and other electrochemical elements, and particularly, are suitable for cathode-active materials of secondary batteries.

### DESCRIPTION OF DRAWINGS

FIG. 1 is a schematic diagram of the cross section of a complex according to one embodiment of the present invention.

FIG. 2 is a schematic diagram of the cross section of an electrode formed by applying complexes to a current collector and rolling them.

FIG. 3 is a scanning electron microscope (SEM) photograph at 500 times magnification of the granular complex prepared in Example 1.

FIG. 4 is a SEM photograph at 50,000 times magnification of a cross section of the granular complex prepared in Example 1.

FIG. 5 is a SEM photograph at 40,000 times magnification of an inner cross section of the granular complex prepared in Example 1, which was cut down with fast ion bombardment (FIB).

FIG. 6 shows a SEM photograph at 1,000 times magnification of the complex prepared in Comparative Example 1 and a SEM photograph at 50,000 times magnification of the surface of said complex.

FIG. 7 shows a photograph at 1,000 times magnification of the complex prepared in Comparative Example 2 and a SEM photograph at 50,000 times magnification of the surface of said complex.

FIG. 8 is the results of X-ray diffraction analysis of the products prepared in Example 1, Examples 11-22, and Comparative Examples 1, 3 and 4.

FIG. 9 is the results of the powder resistance measurement of the products prepared in Examples 1-10.

FIG. 10 is the results of the powder resistance measurement of Example 1 and Comparative Examples 1 and 2.

FIG. 11 is the results of the volume resistance measurement of the products prepared in Examples 11-22 and Comparative Examples 3 and 4.

FIG. 12 is the results of the volume resistance measurement of the products prepared in Examples 12 and 19 and Comparative Examples 3 and 4.

FIG. 13 is the results of the volume resistance measurement of the products prepared in Example 23 and Comparative Example 5.

FIG. 14 is the results of the volume resistance measurement of the products prepared in Example 24 and Comparative Example 6.

FIG. 15 is a graph showing the charge and discharge capacities of Examples 1-10 and Comparative Examples 1 and 2 at various C-rates.

FIG. 16 is a graph showing the charge and discharge capacities of a lithium secondary battery produced by using the granular complex prepared in Example 1 as the cathode-active material.

FIG. 17 is a graph showing the charge and discharge capacities of a lithium secondary battery produced by using the complex prepared in Comparative Example 1 as the cathode-active material.

FIG. 18 is a graph showing the charge and discharge capacities of a lithium secondary battery produced by using the complex prepared in Comparative Example 2 as the cathode-active material.

FIG. 19 is a graph showing the lithium ion diffusion coefficient of the complexes prepared in Example 1 and Comparative Examples 1 and 2.

FIG. 20 is a graph showing the charge and discharge capacities of a lithium secondary battery produced by using the Li₄Ti₅O₁₂-carbon nanotube (CNT) granular complex prepared in Example 24 as the cathode-active material.

FIG. 21 is a graph showing the charge and discharge capacities of a lithium secondary battery produced by using the Li₄Ti₅O₁₂-carbon coating granules prepared in Comparative Example 6 as the cathode-active material.

### MODE FOR INVENTION

### Structure of Complexes

The present invention provides a complex of a transition metal compound and a fibrous carbon material, which comprises an aggregate of primary particles of the transition metal compound as electrode-active material and the fibrous carbon material, wherein the fibrous carbon materials are present in the surface region of the aggregate at a higher density than in the inside region thereof.

“Primary particle” denotes an individual particle which is not aggregated with other particles.

“Surface region” of an aggregate denotes the region which defines the boundary between the aggregate and the outside. The surface region of an aggregate amounts to the surface region of the complex, and the inside of the aggregate amounts to the inside of the complex.

In the present invention, fibrous carbon materials are present in spaces between primary particles in the inside of an aggregate, and are also present in the surface region of the aggregate. They are present sparsely in the inside or in the center region but densely in the surface region of the aggregate.

Fibrous carbon materials present in the inside of an aggregate serve as bridges electrically connecting at least a part of primary particles, and can form a network.

Fibrous carbon materials present in the surface region of an aggregate may form a web.

The transition metal compounds and the fibrous carbon materials constituting a complex can be present in a ratio of 99.9:0.1 to 80:20 by weight. Preferably, the fibrous carbon materials account for 0.5 to 10% by weight of a complex. If the amount of fibrous carbon materials is too small, electric connections between primary particles may be insufficient, or the external surface region of the complex cannot be sufficiently covered with the carbon materials, so that the fibrous carbon materials cannot sufficiently improve the electric conductivity of the complex or cannot properly perform the function of protecting the complex against external influences. On the contrary, if fibrous carbon materials are present in an excessive amount, the amount of transition metal compounds as a constituent of the complex decreases, and then electrodes produced by utilizing such complexes have problems in that they have a low electrode density and eventually have a low battery capacity and, further, the use of excessive carbon materials increases production costs.

The fibrous carbon materials include carbon fibers and carbon nanotubes (CNTs). As CNTs, single-walled, double-walled, thin multi-walled, multi-walled or roped forms or their mixtures can be used. The fibrous carbon materials used in the present invention have an average diameter of 0.5 to 200 nm, and preferably have an average aspect ratio of length to diameter of not less than 10.

It is preferable that the fibrous carbon materials present in the surface region of an aggregate are surface-functionalized and those present in the inside of an aggregate are not surface-functionalized.

Surface functionalization means introducing a chemical functional group onto the surface.

In the present invention, a non-functionalized fibrous carbon material means a fibrous carbon material whose surface is not functionalized.

Introducing chemical functional groups into the surface of a carbon material can increase the dispersibility of the carbon material in a water-based or organic solvent-based solvent. A functional group which can be introduced for the functionalization of the surface of a fibrous carbon material can be the carboxyl group (—COOH), hydroxyl group (—OH), ether group (—COC—), carbohydrate groups (—CH) or the like. Surface functionalization can also be achieved by oxidizing a surface with an oxidant.

A surface-functionalized fibrous carbon material used in the present invention can comprise oxygen, nitrogen or hydrogen at 0.05 to 5% by weight. If the amount of oxygen, nitrogen and hydrogen is too small, the improvement of dispersion properties cannot be expected. On the other hand, if the amount is excessive, it may collapse the structure of the fibrous carbon material and increase resistance.

It is preferable that a complex according to the present invention comprises non-functionalized fibrous carbon materials and surface-functionalized fibrous carbon materials in a ratio of 1:99 to 20:80 by weight.

Further, it is preferable that the ratio of the surface-functionalized fibrous carbon materials to the non-functionalized fibrous carbon materials by weight is higher in the surface region than in the inside of an aggregate.

In the present invention, any transition metal compound can be used as long as it allows reversible intercalation and deintercalation of alkali metal ions. Such transition metal compounds can be classified into spinel structure, layered structure and olivine structure depending on crystal structure.

Examples of the spinel structure compounds include LiMn₂O₄ and Li₄Ti₅O₁₂, and examples of the layered structure compounds include LiCoO₂; LiMnO₂; Li(Ni_{1-x-y}CoₓAl_{y})O₂ (x+y≦1, 0.01≦x≦0.99, 0.01≦y≦0.99); Li(Ni_{1-x-y}MnₓCo_{y})O₂ (x+y≦1, 0.01≦x≦0.99, 0.01≦y≦0.99); and Li_{2-z}(Fe_{1-x-y}M¹ₓM²_{y})_{z}O₂ (x+y≦1, 0.01≦x≦0.99, 0.01≦y≦0.99, 0<z<1, and each of M¹ and M² is Ti, Ni, Zn, or Mn).

In the present invention, a transition metal compound represented by the following chemical formula 1 can be used:

Li₁₋ₓM(PO₄)_{1-y} (1)

In above chemical formula 1, 0≦x≦0.15, 0≦y≦1, and M is represented by the following chemical formula 2:

M^{A}ₐM^{B}_{b}M^{T}ₜFe_{1-(a+b+t)} (2)

In above chemical formula 2, M^{A} is one or more elements selected from the group consisting of the Group 2 elements; M^{B} is one or more elements selected from the group consisting of the Group 13 elements; M^{T} is one or more elements selected from the group consisting of Sc, Ti, V, Cr, Mn, Co, Ni, Cu, Zn, Y, Zr, Nb, and Mo; 0≦a≦1; 0≦b≦0.575; 0≦t≦1; 0≦(a+b)<1; and 0≦(a+b+c)≦1.

In the present invention, a transition metal compound represented by the following chemical formula 3 can also be used:

LiMPO₄ (3)

In the above chemical formula 3, M is one element or the combination of two or more elements selected from the group consisting of Fe, Mn, Ni, Co, Ni, Cu, Zn, Y, Zr, Nb and Mo.

Such transition metal compounds can be prepared by any of the known solid state methods, coprecipitation methods, hydrothermal methods, supercritical hydrothermal methods, sol-gel methods, alkoxide methods, etc.

The size of primary particles as a constituent of a complex of the present invention is not specifically limited, but preferably is 0.01 to 5 μm.

The average particle size of the complexes according to the present invention can be 1 to 200 μm, preferably 3 to 100 μm. If the size of complexes is greater than 200 μm, it is difficult to obtain a coating having a desired thickness when preparing an electrode. On the contrary, if the size is less than 1 μm, processability may deteriorate due to transport and weighing problems caused by powder scattering and flowability decrease.

A complex according to the present invention can have various external shapes such as spherical, cylindrical, rectangular and atypical forms, but a spherical form is preferred in order to increase bulk density and filling rate when producing an electrode.

### Method for Preparing Complexes

A complex according to the present invention can be made by: preparing a mixture wherein non-functionalized fibrous carbon materials, surface-functionalized fibrous carbon materials, and transition metal compounds are dispersed, and wherein the weight of the surface-functionalized fibrous carbon materials is greater than that of the non-functionalized fibrous carbon materials; and then drying and granulating said mixture.

Said mixture can comprise a dispersant in an amount of 10 to 500 parts by weight with respect to 100 parts by weight of the whole fibrous carbon materials.

The transition metal compounds and the fibrous carbon materials can be contained in a ratio of 99.9:0.1 to 80:20 by weight.

Surface functionalization may be achieved by the surface treatment of carbon materials with an oxidant such as oxygen, air, ozone, aqueous hydrogen peroxide or nitro compounds under sub-critical or supercritical conditions of 50 to 400 atm. Surface functionalization can also be achieved by treating the surfaces of carbon materials with a compound having such functional groups as carboxylic acid, carboxylic acid salt, amines, amine salt, quaternary amine, phosphoric acid, phosphoric acid salt, sulfuric acid, sulfuric acid salt, alcohol, thiol, ester, amide, epoxide, aldehyde or ketone at a temperature of 100 to 600° C. under a pressure of 50 to 400 atm. Such surface functionalization can be achieved by oxidizing the surfaces of fibrous carbon materials with carboxylic acid, nitric acid, phosphoric acid, sulfuric acid, hydrofluoric acid, hydrochloric acid, or aqueous hydrogen peroxide.

According to one embodiment of the present invention, a method for preparing a complex can be divided into the following two steps.

First step: Preparation of a dispersion of fibrous carbon materials by dispersing non-functionalized fibrous carbon materials and surface-functionalized fibrous carbon materials in a dispersing medium by a dispersant.

Second step: Preparation of a complex by mixing said dispersion with a transition metal compound, and then drying the resulting mixture by such a method as spray drying.

In preparing a complex, the distribution of fibrous carbon materials in the inside and outside of the complexes can vary depending on the degree of surface treatment of the fibrous carbon materials, the kind and amount of the dispersant, etc.

A dispersion of fibrous carbon materials can be prepared by mixing and dispersing fibrous carbon materials and a dispersant in the presence of an aqueous or non-aqueous dispersing medium.

As a dispersant, a hydrophobic or hydrophilic dispersant can be used. A hydrophilic dispersant disperses surface-functionalized fibrous carbon materials and a hydrophobic one is effective in dispersing non-functionalized fibrous carbon materials.

As a dispersant, polyacetal, acryl-based compound, methyl methacrylate, alkyl (C₁-C₁₀) acrylate, 2-ethylhexylacrylate, polycarbonate, styrene, alpha-methyl styrene, vinyl acrylate, polyesters, vinyl, polyphenylene ether resin, polyolefin, acrylonitrile-butadiene-styrene copolymer, polyarylate, polyamide, polyamideimide, polyarylsulfone, polyetherimide, polyethersulfone, polyphenylene sulfide, fluorine-based compound, polyimide, polyetherketone, polybenzoxazole, polyoxadiazole, polybenzothiazole, polybenzimidazole, polypyridine, polytriazole, polypyrrolidine, polydibenzofuran, polysulfone, polyurea, polyurethane, polyphosphazene, liquid crystal polymer, or copolymer thereof can be used.

In addition, a styrene/acryl-based water-soluble resin formed by polymerizing a styrene-based monomer with an acryl-based monomer can also be used as a dispersant.

Further, as a dispersant, there can be used a polymer formed by subjecting a styrene-based monomer selected from styrene and mixture of styrene and alpha-methyl styrene, and an acryl-based monomer to continuous bulk polymerization in diethyleneglycol monoethylether or a mixed solvent of diethyleneglycol monoethylether and water, at a reaction temperature of 100 to 200° C. In this case, a styrene-based monomer and a acryl-based monomer can be present in a ratio of 60:40 to 80:20 by weight, wherein the styrene-based monomer can comprise either styrene only or styrene and alpha-methyl styrene at a mixing ratio of 50:50 to 90:10 by weight, and the acryl-based monomer can comprise either acrylic acid only or acrylic acid and alkylacrylate monomer in a mixing ratio of 80:20 to 90:10 by weight.

As a dispersant, there can also be used a polymer having a weight average molecular weight of 1,000 to 100,000 and prepared by polymerizing 25 to 45 wt % of styrene, 25 to 45 wt % of alpha-methyl styrene, and 25 to 35 wt % of acrylic acid, with respect to the total weight of the polymer, in the presence of a mixed solvent of diethyleneglycol monoethylether and water.

A dispersant can be included in an amount of 10 to 500 parts by weight with respect to 100 parts by weight of the fibrous carbon materials, and the mixing ratio of a hydrophobic dispersant and a hydrophilic dispersant is preferably within a ratio of 5:95 to 30:70.

As a dispersing medium, water, alcohol, ketone, amine, ester, amide, alkyl halogen, ether or furan can be used.

In the present invention, a complex is prepared by mixing a dispersion containing fibrous carbon materials with transition metal compounds and then drying and granulating the resulting mixture. Here, a drying method which can be used includes spray drying, fluidized-bed drying, etc. If necessary, after the granulation, the resulting product can be heat-treated at 300-1,200° C. to strengthen the crystallinity of the transition metal compounds and to improve electrochemical properties thereof. In conducting such a heat treatment (or calcination), the fibrous carbon materials present in gaps between primary particles play a role of preventing contact between particles, and the web of the carbon materials present in the surface region of the complex play a role of inhibiting aggregation between complexes, thereby inhibiting the growth thereof.

The present invention also provides an electrode produced by using said complex. An electrode can be fabricated by coating a current collector with an electrode material mixture. An electrode has a form which is produced by coating the surface of a conductive metal sheet such as aluminum foil with an electrode material mixture. A current collector has a thickness of 2 to 500 μm, and it is preferred if it does not cause a chemical side reaction when producing an electrode. Examples of the current collectors are those prepared by processing such materials as aluminum, stainless steel, nickel, titanium, silver, etc. into a sheet form. The surface of a current collector may be chemically etched or may be coated with a conductive material.

An electrode material mixture can optionally contain, as its constituents, a conducting agent, binder, and additive, in addition to a complex of the present invention.

The conducting agent can usually account for 1 to 30% by weight of the total weight of an electrode material mixture. As a conducting agent, there can be used any of those which are conductive and which do not cause a side reaction when the electrode is charged and discharged. Examples of the conducting agents are graphite materials such as natural graphite or artificial graphite; carbon black, acetylene black, ketjen black, etc.; fibrous carbon materials; conductive metal oxides such as titanium oxide, etc.; and conductive metal materials such as nickel, aluminum, etc.

A binder is used for combining a complex with a conducting agent or a current collector. A binder is added to account for 1 to 30% by weight of the total electrode material mixture. Examples of the binders are cellulose materials such as cellulose, methyl cellulose, carboxymethyl cellulose, etc.; olefin-based polymer materials such as polyethylene, polypropylene, etc.; polyfluorovinylidene, polyvinylpyrrolidone, polyvinylchloride, etc.; and rubbers such as EPDM, styrene-butylene rubber, fluorinated rubber, etc.

Further, an additive can be used for the purpose of inhibiting the expansion of an electrode. Such additives may be fibrous materials which do not cause any electrochemical side reaction, and can be, for example, olefin-based polymers or copolymers such as polyethylene, polypropylene, etc.; glass fibers, carbon fibers, etc.

The present invention provides secondary batteries, memory devices, or capacitors comprising an electrode prepared by using a transition metal compound-fibrous carbon material complex as an electrode-active material.

Complexes of the present invention can be used in making lithium secondary batteries comprising a cathode, anode, separator membrane and a lithium salt-containing an aqueous or non-aqueous electrolytic solution. As the cathode of a lithium secondary battery, a current collector coated with an electrode material mixture comprising complexes of the present invention can be used. As the anode, a current collector coated with an anode-active material mixture can be used. A separator membrane physically separates an anode from a cathode, and provides a passage for lithium ion movement. As a separator membrane, one having high ion permeability and mechanical strength, and having thermal stability can be used. A non-aqueous electrolytic solution containing a lithium salt comprises an electrolytic solution and the lithium salt. As a non-aqueous electrolytic solution, a non-aqueous organic solvent, organic solid electrolyte, inorganic solid electrolyte, etc. can be used. As a lithium salt, one which can be easily dissolved in a non-aqueous electrolytic solution, for example, LiCl, LiBr, LiI, LiBF₄, LiPF₆, etc. can be used.

The present invention is explained in more detail by the following Examples. However, these Examples are provided only to assist the understanding of the present invention. It is not intended that the scope of the present invention is limited in any manner by these Examples.

### Examples 1-10

### Preparation of a Granular Complex of Lithium Iron Phosphate (LiFePO₄)-Fibrous Carbon Materials

### Step a) Preparation of Dispersions of Fibrous Carbon Materials

Surface-functionalized carbon nanotubes (CNTs) comprising 1.27 wt % of oxygen and 0.21 wt % of hydrogen, non-functionalized CNTs, dispersants made of styrene-acryl-based hydrophilic copolymers, and dispersants made of acryl-based hydrophobic polymers were introduced into distilled water in the ratios shown in the following Table 1, and mixed and dispersed with a homogenizer to produce five kinds of CNT dispersions having different mixing ratios of the surface-functionalized CNTs and the non-functionalized CNTs.

TABLE 1

| | | | Quantity of | | |
|---|---|---|---|---|---|
| | Quantity of | | Dispersant | | Quantity |
| | CNT Added (g) | | Added (g) | | of |
| | Non- | Surface- | Styrene- | | Distilled |
| | func- | func- | acryl- | | Water |
| | tionalized | tionalized | based | Acryl | Added |
| Class | CNT | CNT | copolymers | polymer | (g) |
| Dispersion 1 | 0.3 | 29.7 | 23.76 | 0.24 | 970 |
| Dispersion 2 | 1.5 | 28.5 | 22.8 | 1.2 | 970 |
| Dispersion 3 | 3.0 | 27.0 | 21.6 | 2.4 | 970 |
| Dispersion 4 | 4.5 | 25.5 | 20.4 | 3.6 | 970 |
| Dispersion 5 | 6.0 | 24.0 | 19.2 | 4.8 | 970 |

### Step b) Preparation of Granular Complexes of Transition Metal Compound-Fibrous Carbon Materials

70 g of LiFePO₄ powder wherein the average size of primary particles is 250 nm was introduced into 500 mL of distilled water to prepare a mixture. The CNT dispersions prepared in step a) were added to the mixture as shown in the following Table 2 and then stirred to produce a slurry. The resulting slurry was spray-dried at 180° C. to produce granular complex powders. The granular complex powders thus prepared were calcined for 10 hours in a calcination furnace at 700° C. under an argon (Ar) atmosphere.

TABLE 2

| | | Quantity of Dispersions |
|---|---|---|
| Class | Dispersion | Added (g) |
| Example 1 | Dispersion 1 | 46.0 |
| Example 2 | Dispersion 2 | 46.0 |
| Example 3 | Dispersion 3 | 46.0 |
| Example 4 | Dispersion 4 | 46.0 |
| Example 5 | Dispersion 5 | 46.0 |
| Example 6 | Dispersion 3 | 11.7 |
| Example 7 | Dispersion 3 | 23.3 |
| Example 8 | Dispersion 3 | 58.3 |
| Example 9 | Dispersion 3 | 70.0 |
| Example 10 | Dispersion 3 | 116.6 |

The granular complex powders obtained as a result of the calcination were analyzed with X-ray diffraction to determine their crystal structures, and the content of carbon therein was measured by an elemental analyzer. In addition, a laser diffraction particle size analyzer was used to analyze the particle size of the granules, and a scanning electron microscope (SEM) was used to examine the shapes of the granules and the distribution modes of transition metal compounds and CNTs. Further, the ratios of elements were measured by inductively coupled plasma-atomic emission spectroscopy (ICP-AES).

### Example 11

### Preparation of a Complex Comprising LiMPO₄ (M is a Combination of Fe, Mn, and Co) and Carbon Nanotubes

34.7 g of ferrous sulfate heptahydrate [FeSO₄.7H₂O], 36.3 g of nickel nitrate [Ni(NO₃)₂.6H₂O], 43.7 g of manganese nitrate [Mn(NO₃)₂.6H₂O], and 36.4 g of cobalt nitrate [Co(NO₃)₂.6H₂O], and 48.95 g of phosphoric acid (H₃PO₄) were added to produce a first solution. 24 g of lithium hydroxide monohydrate (LiOH.H₂O) and 200 mL of 28% ammonium hydroxide (NH₄OH) solution were mixed, and 200 mL of distilled water was added thereto to produce a second solution.

The first solution was added to a reactor and, while stirring, the second solution was added thereto. Upon completion of the addition, the reactor was closed, heated, kept at a temperature of 180° C. for 4 hours, and then cooled to room temperature. The cooled mixture was removed from the reactor and washed three times with 500 mL of distilled water through a filter having a pore size of 0.2 μm. Upon completion of the washing, the resulting product in the form of a cake was diluted with distilled water to the concentration of solid components of 30% to prepare a concentrated slurry of the lithium transition metal compound (LiFeMnCoPO₄).

200 g of dispersion 3 prepared in step a) of Example 1 was added to 1 kg of the concentrated slurry of said lithium transition metal compound (LiFeMnCoPO₄) and then mixing was conducted for 30 minutes and spray dry was performed to obtain granular powder. The resulting powder was calcined for 10 hours in a calcining furnace at 700° C. under an argon (Ar) atmosphere to produce a granular complex, which was then analyzed.

### Example 12

### Preparation of a Complex Comprising LiMPO₄ (M is a Combination of Mn and Fe) Having an Olivine Structure, and Carbon Nanotubes

0.5 mol of manganese sulfate (MnSO₄) and 0.5 mol of ferrous sulfate (FeSO₄) as precursors of the metal M, 1 mol of phosphoric acid as a phosphoric acid compound, and 27.8 g of sugar as a reducing agent were dissolved in 1.6 L of water to prepare a first solution. 1.5 mol of ammonia as an alkalizing agent and 2 mol of lithium hydroxide as a lithium precursor were dissolved in 1.2 L of water to prepare a second solution.

The first solution and the second solution were processed in the order of the following steps (a), (b), and (c) by a continuous-type reaction apparatus to prepare lithium manganese iron phosphate.

A tubular, continuous-type reaction apparatus was used. The raw material solutions were mixed in a first mixer and then went through a second mixer in which distilled water of a high temperature was mixed therewith, went through a tubular reactor region maintained at a high temperature, and then went through a cooling section and a pressure-release apparatus.

Step (a): While maintaining the total pressure of the reaction apparatus at 250 bars, the first solution and the second solution were continuously pumped under pressure at normal temperature into the first mixer to be mixed therein to produce a slurry comprising the precursor of a lithium transition metal phosphate compound.

Step (b): The precursor slurry from step (a) and ultra-pure water heated to 450° C. were pressurized under 250 bars and pumped into the second mixer to be mixed therein. The mixture was transferred to a reactor maintained at 380° C. and 250 bars and left therein for 7 seconds to continuously synthesize a lithium transition metal phosphate compound, which was then cooled and pressure-released to obtain a slurry concentrate having a solid content of 30%. 1.0 kg of this concentrate was mixed with 200 g of dispersion 3 prepared in step a) of Example 1, stirred for 30 minutes, and then spray-dried at 180° C. to form granules.

Step (c): The dry granules formed through the spray-drying in step (b) were calcined for 10 hours in a calcination furnace at 700° C. under an argon (Ar) atmosphere to produce final granular complex powder.

Said final granular complex was confirmed as having an olivine structure by means of X-ray diffraction (XRD) analysis. In addition, the final granular complex was identified to be Li_{0.89}(Mn_{0.25}Fe_{0.75})(PO₄)_{0.96} from the molar ratios of the constituent elements analyzed by ICP-AES.

### Example 13

### Preparation of a Complex Comprising LiMPO₄ (M is Mn) Having an Olivine Structure, and Carbon Nanotubes

1 mol of manganese sulfate, 1 mol of phosphoric acid, and 27.8 g of sugar were dissolved in 1.6 L of water to prepare a first solution. 1.5 mol of ammonia and 2 mol of lithium hydroxide were dissolved in 1.2 L of water to prepare a second solution.

The first solution and the second solution were processed according to steps (a), (b), and (c) of Example 12 to prepare a LiMnPO₄-carbon nanotube granular complex.

Said LiMnPO₄-carbon nanotube granular complex was confirmed as having an olivine structure by means of XRD analysis. In addition, the LiMnPO₄-carbon nanotube granular complex was identified to be Li_{0.91}Mn(PO₄)_{0.97} from the molar ratios of the constituent elements analyzed by ICP-AES.

### Example 14

### Preparation of a Complex Comprising LiMPO₄ (M is a Combination of Co and Fe) Having an Olivine Structure, and Carbon Nanotubes

0.50 mol of cobalt nitrate, 0.50 mol of ferrous sulfate, 1 mol of phosphoric acid, and 27.8 g of sugar were dissolved in 1.6 L of water to prepare a first solution. 1.5 mol of ammonia and 2 mol of lithium hydroxide were dissolved in 1.2 L of water to prepare a second solution.

The first solution and the second solution were processed according to steps (a), (b), and (c) of Example 12 to prepare a Li(CoFe)PO₄-carbon nanotube granular complex.

Said Li(CoFe)PO₄-carbon nanotube granular complex was confirmed as having an olivine structure by means of XRD analysis. In addition, the Li(CoFe)PO₄-carbon nanotube granular complex was identified to be Li_{0.91}(Co_{0.50}Fe_{0.50})(PO₄)_{0.97} from the molar ratios of the constituent elements analyzed by ICP-AES.

### Example 15

### Preparation of a Complex Comprising LiMPO₄ (M is Co) Having an Olivine Structure, and Carbon Nanotubes

1 mol of cobalt nitrate, 1 mol of phosphoric acid, and 27.8 g of sugar were dissolved in 1.6 L of water to prepare a first solution. 1.5 mol of ammonia and 2 mol of lithium hydroxide were dissolved in 1.2 L of water to prepare a second solution.

The first solution and the second solution were processed according to steps (a), (b), and (c) of Example 12 to prepare a LiCoPO₄-carbon nanotube granular complex.

Said LiCoPO₄-carbon nanotube granular complex was confirmed as having an olivine structure by means of XRD analysis. In addition, the LiCoPO₄-carbon nanotube granular complex was identified to be Li_{0.90}Co(PO₄)_{0.97} from the molar ratios of the constituent elements analyzed by ICP-AES.

### Example 16

### Preparation of a Complex Comprising LiMPO₄ (M is a Combination of Ni and Fe) Having an Olivine Structure, and Carbon Nanotubes

0.50 mol of nickel nitrate, 0.50 mol of ferrous sulfate, 1 mol of phosphoric acid, and 27.8 g of sugar were dissolved in 1.6 L of water to prepare a first solution. 1.5 mol of ammonia and 2 mol of lithium hydroxide were dissolved in 1.2 L of water to prepare a second solution.

The first solution and the second solution were processed according to steps (a), (b), and (c) of Example 12 to prepare a Li(NiFe)PO₄-carbon nanotube granular complex.

Said Li(NiFe)PO₄-carbon nanotube granular complex was confirmed as having an olivine structure by means of XRD analysis. In addition, the Li(NiFe)PO₄-carbon nanotube granular complex was identified to be Li_{0.92}(Ni_{0.50}Fe_{0.50})(PO₄)_{0.97} from the molar ratios of the constituent elements analyzed by ICP-AES.

### Example 17

### Preparation of a Complex Comprising LiMPO₄ (M is Ni) Having an Olivine Structure, and Carbon Nanotubes

1 mol of nickel nitrate, 1 mol of phosphoric acid, and 27.8 g of sugar were dissolved in 1.6 L of water to prepare a first solution. 1.5 mol of ammonia and 2 mol of lithium hydroxide were dissolved in 1.2 L of water to prepare a second solution.

The first solution and the second solution were processed according to steps (a), (b), and (c) of Example 12 to prepare a LiNiPO₄-carbon nanotube granular complex.

Said LiNiPO₄-carbon nanotube granular complex was confirmed as having an olivine structure by means of XRD analysis. In addition, the LiNiPO₄-carbon nanotube granular complex was identified to be Li_{0.93}Ni(PO₄)_{0.98} from the molar ratios of the constituent elements analyzed by ICP-AES.

### Example 18

### Preparation of a Complex Comprising LiMPO₄ (M is a Combination of Mn, Co and Ni) Having an Olivine Structure, and Carbon Nanotubes

⅓ mol of manganese sulfate, ⅓ mol of cobalt nitrate, ⅓ mol of nickel nitrate, 1 mol of phosphoric acid, and 27.8 g of sugar were dissolved in 1.6 L of water to prepare a first solution. 1.5 mol of ammonia and 2 mol of lithium hydroxide were dissolved in 1.2 L of water to prepare a second solution.

The first solution and the second solution were processed according to steps (a), (b), and (c) of Example 12 to prepare a Li(MnCoNi)PO₄-carbon nanotube granular complex.

Said Li(MnCoNi)PO₄-carbon nanotube granular complex was confirmed as having an olivine structure by means of XRD analysis. In addition, the Li(MnCoNi)PO₄-carbon nanotube granular complex was identified to be Li_{0.89}(Mn_{0.33}Co_{0.33}Ni_{0.33})(PO₄)_{0.96} from the molar ratios of the constituent elements analyzed by ICP-AES.

### Example 19

### Preparation of a Complex Comprising LiMPO₄ (M is a Combination of Mn, Co, Ni and Fe) Having an Olivine Structure, and Carbon Nanotubes

0.25 mol of manganese sulfate, 0.25 mol of cobalt nitrate, 0.25 mol of nickel nitrate, 0.25 mol of ferrous sulfate, 1 mol of phosphoric acid, and 27.8 g of sugar were dissolved in 1.6 L of water to prepare a first solution. 1.5 mol of ammonia and 2 mol of lithium hydroxide were dissolved in 1.2 L of water to prepare a second solution.

The first solution and the second solution were processed according to steps (a), (b), and (c) of Example 12 to prepare a Li(MnCoNiFe)PO₄-carbon nanotube granular complex.

Said Li(MnCoNiFe)PO₄-carbon nanotube granular complex was confirmed as having an olivine structure by means of XRD analysis. In addition, the Li(MnCoNiFe)PO₄-carbon nanotube granular complex was identified to be Li_{0.90}(Mn_{0.25}Co_{0.25}Ni_{0.25}Fe_{0.25})(PO₄)_{0.97} from the molar ratios of the constituent elements analyzed by ICP-AES.

### Example 20

### Preparation of a Complex Comprising LiMPO₄ (M is a Combination of Mg and Fe) Having an Olivine Structure, and Carbon Nanotubes

0.07 mol of magnesium sulfate (MgSO₄), 0.93 mol of ferrous sulfate, 1 mol of phosphoric acid, and 27.8 g of sugar were dissolved in 1.6 L of water to prepare a first solution. 1.5 mol of ammonia and 2 mol of lithium hydroxide were dissolved in 1.2 L of water to prepare a second solution.

The first solution and the second solution were processed according to steps (a), (b), and (c) of Example 12 to prepare a Li(MgFe)PO₄-carbon nanotube granular complex.

Said Li(MgFe)PO₄-carbon nanotube granular complex was confirmed as having an olivine structure by means of XRD analysis. In addition, the Li(MgFe)PO₄-carbon nanotube granular complex was identified to be Li_{0.88}(Mg_{0.07}Fe_{0.93})(PO₄)_{0.96} from the molar ratios of the constituent elements analyzed by ICP-AES.

### Example 21

### Preparation of a Complex Comprising LiMPO₄ (M is a Combination of Mg and Mn) Having an Olivine Structure, and Carbon Nanotubes

0.10 mol of magnesium sulfate, 0.90 mol of manganese sulfate, 1 mol of phosphoric acid, and 27.8 g of sugar were dissolved in 1.6 L of water to prepare a first solution. 1.5 mol of ammonia and 2 mol of lithium hydroxide were dissolved in 1.2 L of water to prepare a second solution.

The first solution and the second solution were processed according to steps (a), (b), and (c) of Example 12 to prepare a Li(MgMn)PO₄-carbon nanotube granular complex.

Said Li(MgMn)PO₄-carbon nanotube granular complex was confirmed as having an olivine structure by means of XRD analysis. In addition, the Li(MgMn)PO₄-carbon nanotube granular complex was identified to be Li_{0.92}(Mg_{0.10}Mn_{0.90})(PO₄)_{0.97} from the molar ratios of the constituent elements analyzed by ICP-AES.

### Example 22

### Preparation of a Complex Comprising LiMPO₄ (M is a Combination of Al, Mn and Fe) Having an Olivine Structure, and Carbon Nanotubes

0.03 mol of aluminum nitrate (Al(NO₃)₃), 0.78 mol of manganese sulfate, 0.19 mol of ferrous sulfate, 1 mol of phosphoric acid, and 27.8 g of sugar were dissolved in 1.6 L of water to prepare a first solution. 1.5 mol of ammonia and 2 mol of lithium hydroxide were dissolved in 1.2 L of water to prepare a second solution.

The first solution and the second solution were processed according to steps (a), (b), and (c) of Example 12 to prepare a Li(AlMnFe)PO₄-carbon nanotube granular complex.

Said Li(AlMnFe)PO₄-carbon nanotube granular complex was confirmed as having an olivine structure by means of XRD analysis. In addition, the Li(AlMnFe)PO₄-carbon nanotube granular complex was identified to be Li_{0.85}(Al_{0.03}Mn_{0.78}Fe_{0.19})(PO₄)_{0.98} from the molar ratios of the constituent elements analyzed by ICP-AES.

### Example 23

### Preparation of a Complex Comprising a Ternary-System Li(NiMnCo)O₂ and Carbon Nanotubes

0.25 mol of manganese sulfate, 0.25 mol of cobalt nitrate, and 0.25 mol of nickel nitrate as precursors of the metal M were dissolved in 1.6 L of water to prepare a first solution. 1.5 mol of ammonia as an alkalizing agent and 2 mol of lithium hydroxide as a lithium precursor were dissolved in 1.2 L of water to prepare a second solution.

The first solution and the second solution were processed in the order of the following steps (a), (b), and (c) to prepare a lithium manganese nickel cobalt oxide.

Step (a): The first solution and the second solution were continuously pumped under pressure of 250 bars at normal temperature into a mixer and were mixed therein to produce a slurry comprising a precursor of a lithium transition metal phosphate compound.

Step (b): Ultra-pure water heated to 450° C. was pressurized to 250 bars and was pumped into the precursor slurry of step (a) to be mixed in a mixer. The mixed solution was transferred to a reactor maintained at 380° C. and 250 bars and left therein for 7 seconds to continuously synthesize a lithium transition metal phosphate compound, which was then cooled to obtain a slurry concentrate having a solid content of 30%. 1.0 kg of this concentrate was mixed with 168.5 g of dispersion 3 prepared in step a) of Example 1, stirred for 30 minutes, and then spray-dried at 180° C. to form granules.

Step (c): The dry granules formed through the spray-drying in step (b) were calcined for 10 hours at 700° C. under an argon (Ar) atmosphere to prepare final granular complex powder.

Said granular complex was confirmed as having a layered structure by means of XRD analysis. In addition, the granular complex was identified to be Li(Mn_{0.33}Ni_{0.33}Co_{0.33})O₂ from the molar ratios of the constituent elements analyzed by ICP-AES.

### Example 24

### Preparation of a Complex Comprising Lithium Titanate (Li₄Ti₅O₁₂) Having a Spinel Structure and Carbon Nanotubes

40.0 g of Li₂CO₃, 79.9 g of TiO₂, 500 g of distilled water and 51.6 g of dispersion 3 prepared in step a) of Example 1 were introduced together with 200 g of zirconia balls having a diameter of 10 mm into a cylindrical teflon vessel of 1.0 L volume, mixed for 12 hours by ball mill, and then spray-dried at a temperature of 180° C., and calcined for 4 hours in a calcinations furnace under an argon (Ar) atmosphere at a temperature of 750° C. to prepare final granular complex powder.

Said granular complex was confirmed as having a spinel structure by means of XRD analysis. In addition, the granular complex was identified to be Li₄Ti₅O₁₂ from the molar ratios of the constituent elements analyzed by ICP-AES.

### Comparative Example 1

### Preparation of LiFePO₄ Powder Coated with Carbon

1 kg of LiFePO₄ powder and 80 g of sucrose were added to 9 kg of distilled water and stirred for 30 minutes, and then dried by means of a spray dryer. The dried powder was calcined for 10 hours at 700° C. under an argon (Ar) atmosphere to prepare LiFePO₄ complex powder uniformly coated with carbon.

Said LiFePO₄ complex powder coated with carbon had a carbon content of 2.2%, and was identified as having an average particle size of 21.0 μm as determined by a laser diffraction particle size analyzer.

### Comparative Example 2

### Preparation of a Complex Comprising LiFePO₄ Particles Coated with Carbon and Carbon Nanotubes

1 kg of LiFePO₄ powder and 80 g of sucrose were mixed with 666.6 g of dispersion 3 prepared in step a) of Example 1, and 9 kg of distilled water was added thereto, and the mixture was then stirred for 1 hour and spray-dried at a temperature of 180° C. to produce granular powder. The resulting granular powder was calcined for 10 hours at 700° C. under an argon (Ar) atmosphere to obtain complex powder comprising LiFePO₄ particles coated with carbon and carbon nanotubes (CNTs).

Said complex had a carbon content of 4.3%, and was identified as having an average particle size of 22.2 μm as determined by a laser diffraction particle size analyzer.

### Comparative Example 3

### Preparation of LiMPO₄ (M is a Combination of Mn and Fe)

0.25 mol of manganese sulfate (MnSO₄) and 0.75 mol of ferrous sulfate (FeSO₄) as precursors of the metal M, 1 mol of phosphoric acid as a phosphoric acid compound, and 27.8 g of sugar as a reducing agent were dissolved in 1.6 L of water to prepare a first solution. 1.5 mol of ammonia as an alkalizing agent and 2 mol of lithium hydroxide as a lithium precursor were dissolved in 1.2 L of water to prepare a second solution.

The first solution and the second solution were processed in the order of the following steps (a), (b), and (c) to prepare anion-deficient lithium manganese iron phosphate.

Step (a): The first solution and the second solution were continuously pumped under pressure of 250 bars at normal temperature into a mixer to be mixed therein to produce a slurry comprising the precursor of lithium transition metal phosphate compound.

Step (b): Ultra-pure water heated to 450° C. was pressurized under 250 bars and pumped into the precursor slurry of step (a) to be mixed in a mixer. The mixed solution was transferred to a reactor maintained at 380° C., 250 bars and left therein for 7 seconds to continuously synthesize an anion-deficient lithium transition metal phosphate compound having low crystallinity, which was then cooled and concentrated. The resulting concentrate was mixed with sucrose, which was a carbon precursor, and was in an amount of 10% relative to the lithium transition metal phosphate compound in the concentrate, and then dried via a spray dryer to form granules.

Step (c): The dry granules formed through the spray-drying in step (b) were calcined in a calcinations furnace under an argon (Ar) atmosphere at 700° C. for 10 hours to prepare a lithium transition metal phosphate compound whose particle surface was coated with carbon.

Said lithium transition metal phosphate compound coated with carbon was confirmed as having an olivine structure by means of XRD analysis. In addition, said lithium transition metal phosphate compound was identified to be Li_{0.9}(Mn_{0.5}Fe_{0.5})(PO₄)_{0.96} from the molar ratios of the constituent elements analyzed by ICP-AES.

### Comparative Example 4

### Preparation of LiMPO₄ (M is a Combination of Mn, Ni, Co and Fe)

0.25 mol of manganese sulfate, 0.25 mol of cobalt nitrate, 0.25 mol of nickel nitrate, 0.25 mol of ferrous sulfate, 1 mol of phosphoric acid, and 27.8 g of sugar were dissolved in 1.6 L of water to prepare a first solution. 1.5 mol of ammonia and 2 mol of lithium hydroxide were dissolved in 1.2 L of water to prepare a second solution.

The first solution and the second solution were processed in the order of the following steps (a), (b), and (c) by using the same reaction apparatus as used in Example 1, to prepare Li(FeMnNiCo)PO₄.

Step (a): The first solution and the second solution were continuously pumped under pressure of 250 bars at normal temperature into a mixer to mixed therein to produce a slurry comprising a precursor of a lithium transition metal phosphate compound.

Step (b): Ultra-pure water heated to 450° C. was pressurized under 250 bars and pumped into the precursor slurry of step (a) to be mixed in a mixer. The mixed solution was transferred to a reactor maintained at 380° C., 250 bars and left therein for 7 seconds to continuously synthesize a low-crystallizing, anion-deficient lithium transition metal phosphate compound, which was then cooled and concentrated. The resulting concentrate was mixed with sucrose, which was a carbon precursor and was in an amount of 10% relative to the lithium transition metal phosphate compound in the concentrate, and then dried via a spray dryer to form granules.

Step (c): The dry granules formed through the spray-drying in step (b) were calcined in a calcination furnace under an argon (Ar) atmosphere at 700° C. for 10 hours to prepare a lithium transition metal phosphate compound whose particle surface was coated with carbon.

Said lithium transition metal phosphate compound coated with carbon was confirmed as having an olivine structure by means of XRD analysis. In addition, said lithium transition metal phosphate compound was also identified to be Li_{0.90}(Mn_{0.25}Co_{0.25}Ni_{0.25}Fe_{0.25})(PO₄)_{0.97} from the molar ratios of the constituent elements analyzed by ICP-AES.

### Comparative Example 5

### Preparation of Li(MnNiCo)O₂

0.25 mol of manganese sulfate, 0.25 mol of cobalt nitrate, and 0.25 mol of nickel nitrate as precursors of the metal M were dissolved in 1.6 L of water to prepare a first solution. 1.5 mol of ammonia as an alkalizing agent and 2 mol of lithium hydroxide as a lithium precursor were dissolved in 1.2 L of water to prepare a second solution.

The first solution and the second solution were processed in the order of the following steps (a), (b), and (c) by using the same reaction apparatus as used in Example 1, to prepare lithium manganese nickel cobalt phosphate.

Step (a): Said two aqueous solutions were continuously pumped under pressure of 250 bars at normal temperature into a mixer to be mixed therein to produce a slurry comprising the precursor of a lithium transition metal phosphate compound.

Step (b): Ultra-pure water heated to 450° C. was pressurized under 250 bars and pumped into the precursor slurry of step (a) to be mixed in a mixer. The mixed solution was transferred to a reactor maintained at 380° C., 250 bars and left therein for 7 seconds to continuously synthesize lithium transition metal oxide, which was then cooled and concentrated to a slurry having a solid content of 30%. The resulting concentrate was spray-dried at 180° C. to form granules.

Step (c): The dry granules formed through the spray-drying in step (b) were calcined under an oxidizing atmosphere at 900° C. for 12 hours to prepare final granular complex powder.

Said granular complex was confirmed as having a layered structure by means of XRD analysis. In addition, said granular complex was identified to be Li(Mn_{0.33}Ni_{0.33}Co_{0.33})O₂ from the molar ratios of the constituent elements analyzed by ICP-AES.

### Comparative Example 6

### Preparation of Li₄Ti₅O₁₂

40 g of Li₂CO₃, 79.9 g of TiO₂, 500 g of distilled water, and 7.4 g of sucrose were introduced together with 200 g of zirconia balls having a diameter of 10 mm into a cylindrical Teflon vessel with 1.0 L volume, mixed for 12 hours by a ball mill, and then spray-dried at temperature of 180° C., and calcined for 4 hours in a calcination furnace under atmospheric conditions at a temperature of 750° C. to prepare granular complex powder.

Said granular complex was confirmed as having a spinel structure by means of XRD analysis. In addition, the granular complex was identified to be Li₄Ti₅O₁₂ from the molar ratios of the constituent elements analyzed by ICP-AES, and identified as having a carbon content of 2.2%.

### Shapes of Powder

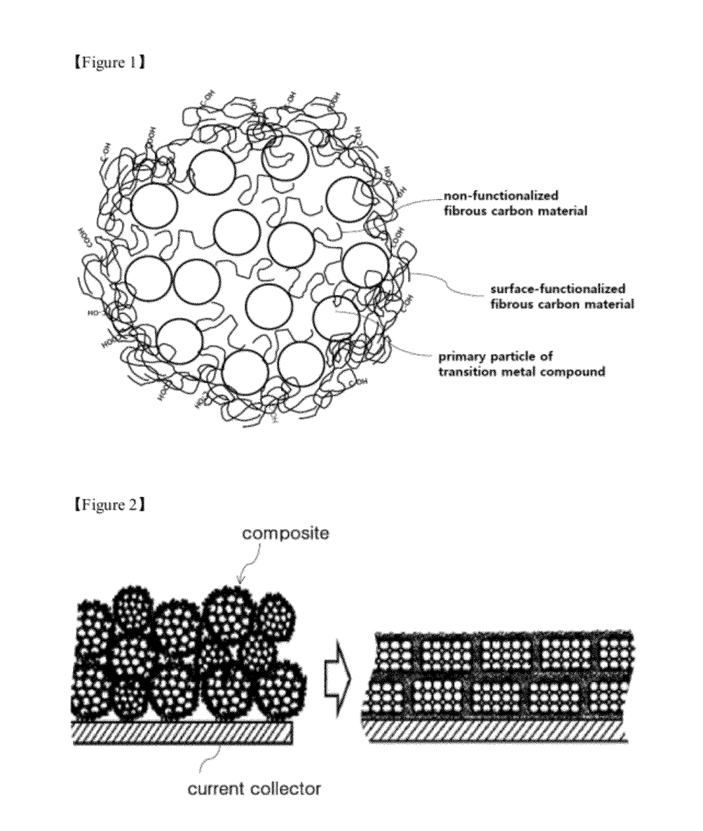

FIG. 1 is a schematic diagram of the cross section of a complex of the present invention, in which fibrous carbon materials are present at a higher density in the surface region of the complex and at a relatively lower density in the inside of the complex. Since fibrous carbon materials are present relatively densely in the surface region of the complex, when preparing an electrode by applying electrode materials to a current collector and rolling them, as described in FIG. 2, adjacent complexes are continuously electrically connected by fibrous carbon materials and greatly increase the electric conductivity of the complexes, thereby remarkably increasing high-rate capability. Further, electrode-active materials contact the current collector over a larger area due to the medium of the fibrous carbon materials and thus adhesion increases and the life properties and stability of the electrode are improved.

The final complexes prepared in Example 1, Comparative Example 1, and Comparative Example 2 were each analyzed by a scanning electron microscope (SEM) for the determination of their powder shapes.

In the case of the powder prepared in Example 1, a granule was cut down for the observation of the inner cross section of the granule.

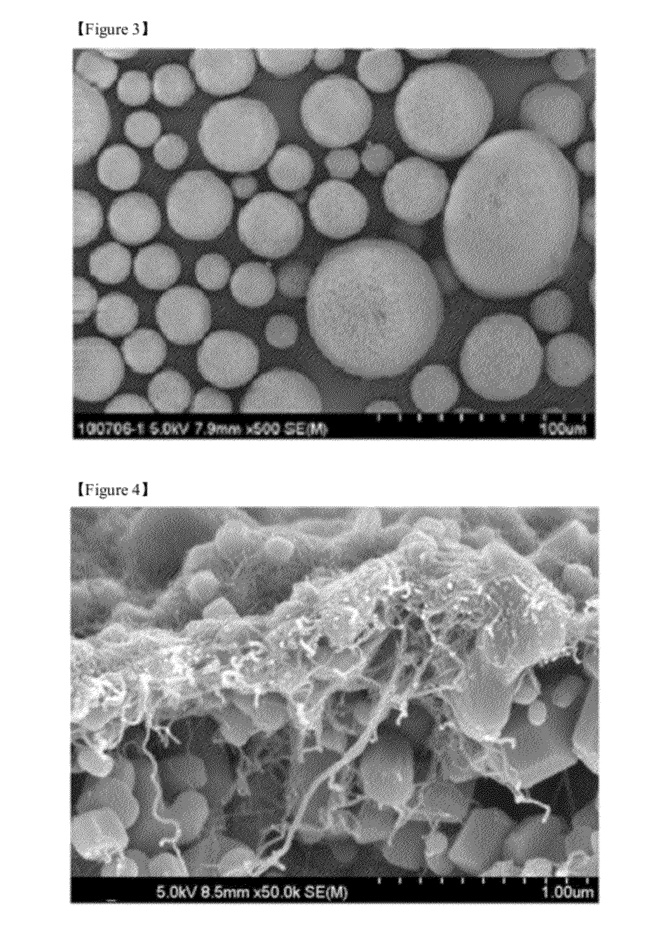

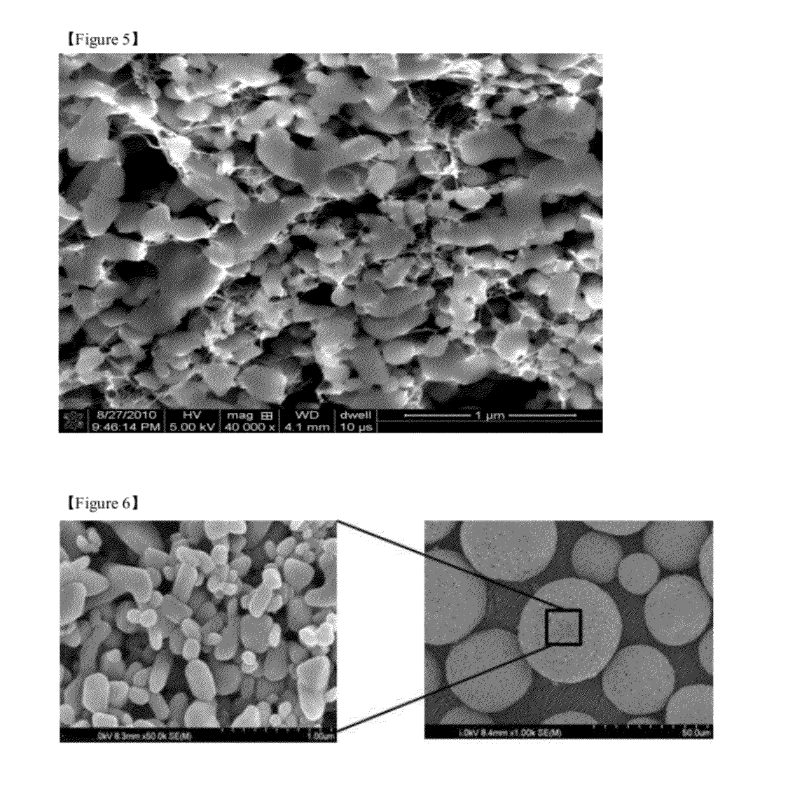

FIG. 3 is a SEM photograph at 500 magnification of the shape of the granular complex powder of Example 1; FIG. 4 is a SEM photograph of an outer cross section of the granule including the surface and FIG. 5 is a SEM photograph of an inner side cross section of the granule obtained by cutting down the granule with fast ion bombardment (FIB). From the figures, it is confirmed that the external surface of the complex is covered with dense carbon nanotube (CNT) web, and the inside of the complex has a network structure wherein LiFePO₄ primary particles are connected by CNTs.

FIG. 6 is a SEM photograph of LiFePO₄ primary particles coated with carbon according to Comparative Example 1. FIG. 7 is a SEM photograph of complexes which have carbon coatings and CNTs of Comparative Example 2, from which it is confirmed that CNTs densely cover the external surfaces of the granules.

### Compositions and Crystal Structures of Final Products

The final complexes prepared in Examples 1 to 24 and Comparative Examples 1 to 6 were assayed to determine the compositional ratios of respective elements by ICP-AES, and the results are shown in the following Table 3.

TABLE 3

| | | Crystal | Atomic Mole Ratio (by ICP-AES) | | | | | | | | |
|---|---|---|---|---|---|---|---|---|---|---|---|
| Class | Chemical Formula | Phase | Li | Fe | P | Mn | Ni | Co | Ti | Mg | Al |
| Examples 1-10 | LiFePO₄ | olivine | 0.98 | 1.00 | 1.00 | | | | | | |
| Example 11 | Li(FeMnNiCo)PO₄ | olivine | 1.00 | 0.25 | 1.00 | 0.25 | 0.25 | 0.25 | | | |
| Example 12 | Li(FeMn)PO₄ | olivine | 0.90 | 0.50 | 0.96 | 0.50 | | | | | |
| Example 13 | LiMnPO₄ | olivine | 0.91 | | 0.97 | 1.00 | | | | | |
| Example 14 | Li(FeCo)PO₄ | olivine | 0.91 | 0.50 | 0.97 | | | 0.50 | | | |
| Example 15 | LiCoPO₄ | olivine | 0.90 | | 0.97 | | | 1.00 | | | |
| Example 16 | Li(FeNi)PO₄ | olivine | 0.92 | 0.50 | 0.97 | | 0.50 | | | | |
| Example 17 | LiNiPO₄ | olivine | 0.93 | | 0.98 | | 1.00 | | | | |
| Example 18 | Li(MnNiCo)PO₄ | olivine | 0.89 | | 0.96 | 0.33 | 0.33 | 0.33 | | | |
| Example 19 | Li(FeMnNiCo)PO₄ | olivine | 0.90 | 0.25 | 0.97 | 0.25 | 0.25 | 0.25 | | | |
| Example 20 | Li(MgFe)PO₄ | olivine | 0.88 | 0.93 | 0.96 | | | | | 0.07 | |
| Example 21 | Li(MgMn)PO₄ | olivine | 0.92 | | 0.97 | 0.90 | | | | 0.10 | |
| Example 22 | Li(AlFeMn)PO₄ | olivine | 0.85 | 0.19 | 0.98 | 0.78 | | | | | 0.03 |
| Example 23 | Li(NiMnCo)O₂ | layered | 1.00 | | | 0.33 | 0.33 | 0.33 | | | |
| Example 24 | Li₄Ti₅O₁₂ | spinel | 0.80 | | | | | | 1.00 | | |
| Comparative | LiFePO₄ | olivine | 0.98 | 1.00 | 1.00 | | | | | | |
| Example 1 | | | | | | | | | | | |
| Comparative | LiFePO₄ | olivine | 0.98 | 1.00 | 1.00 | | | | | | |
| Example 2 | | | | | | | | | | | |
| Comparative | Li(FeMn)PO₄ | olivine | 0.90 | 0.50 | 0.96 | 0.50 | | | | | |
| Example 3 | | | | | | | | | | | |
| Comparative | Li(FeNiMnCo)PO₄ | olivine | 1.00 | 0.25 | 1.00 | 0.25 | 0.25 | 0.25 | | | |
| Example 4 | | | | | | | | | | | |
| Comparative | Li(NiMnCo)O₂ | layered | 1.00 | | | 0.33 | 0.33 | 0.33 | | | |
| Example 5 | | | | | | | | | | | |
| Comparative | Li₄Ti₅O₁₂ | spinel | 0.80 | | | | | | 1.00 | | |
| Example 6 | | | | | | | | | | | |

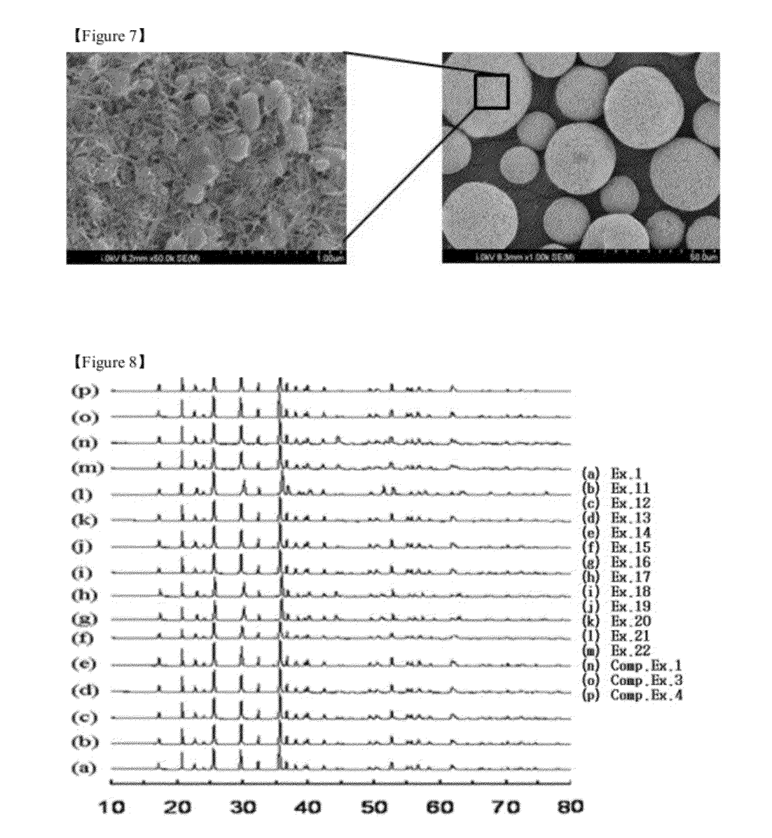

Further, the crystal structures of the final complexes prepared in Examples 1 and 11-22, and Comparative Examples 1, 3 and 4 were analyzed by XRD analysis, and are shown in FIG. 8. As can be confirmed from each graph of FIG. 8, the final complexes prepared in Examples 1 and 11-22, and Comparative Examples 1, 3, and 4 have the pure olivine crystal structure and do not comprise any impurity phase.

### Carbon Content, Specific Surface Area, Particle Size, and Powder Resistance of Powder

Regarding the final granular complexes prepared in Examples 1-24 and Comparative Examples 1-6, carbon content was measured by elementary analysis, the average particle size of the granules was measured by a laser diffraction particle size analyzer, and the specific surface area of powder was measured by the BET method. For the determination of the electric conductive properties of the powder, volume resistance was measured depending on compressive strength by a powder resistant tester. The results are shown in the following Table 4.

TABLE 4

| | | | | Average | Specific | | | | | |
|---|---|---|---|---|---|---|---|---|---|---|
| | CNT Ratio | | Carbon | Particle | Surface | Volume Resistance of Powder (Ohm-cm) | | | | |
| | n- | s- | Content | Size | Area | 4 KN | 8 KN | 12 KN | 16 KN | 20 KN |
| | CNT* | CNT** | (wt %) | (μm) | (m²/g) | 12.73 MPa | 25.46 MPa | 38.19 MPa | 50.92 MPa | 63.66 MPa |
| Ex. 1 | 1 | 99 | 2.1 | 16.00 | 15.40 | 5.190E+01 | 3.767E+01 | 2.297E+01 | 2.297E+01 | 1.989E+01 |
| Ex. 2 | 5 | 95 | 2.2 | 17.50 | 15.20 | 5.490E+01 | 4.812E+01 | 3.867E+01 | 2.997E+01 | 2.189E+01 |
| Ex. 3 | 10 | 90 | 2.0 | 19.00 | 15.90 | 6.190E+01 | 40512E+01 | 3.767E+01 | 3.297E+01 | 2.589E+01 |
| Ex. 4 | 15 | 85 | 2.0 | 20.00 | 15.10 | 6.590E+01 | 4.912E+01 | 4.261E+01 | 3.697E+01 | 3.189E+01 |
| Ex. 5 | 20 | 80 | 2.0 | 21.30 | 15.80 | 7.390E+01 | 5.712E+01 | 4.967E+01 | 4.097E+01 | 3.389E+01 |
| Ex. 6 | 10 | 90 | 0.5 | 20.40 | 12.80 | 6.570E+02 | 4.892E+02 | 3.947E+02 | 3.287E+02 | 2.909E+02 |
| Ex. 7 | 10 | 90 | 1.0 | 20.30 | 13.60 | 3.190E+02 | 2.512E+02 | 1.547E+02 | 8.597E+01 | 7.489E+01 |
| Ex. 8 | 10 | 90 | 2.5 | 20.50 | 16.70 | 5.290E+01 | 3.812E+01 | 2.767E+01 | 1.897E+01 | 1.089E+01 |
| Ex. 9 | 10 | 90 | 3.0 | 20.40 | 18.30 | 1.190E+01 | 9.116E+00 | 7.670E+00 | 6.968E+00 | 6.893E+00 |
| Ex. 10 | 10 | 90 | 5.0 | 20.70 | 22.20 | 6.987E+00 | 4.116E+00 | 3.270E+00 | 2.682E+00 | 1.893E+00 |
| Ex. 11 | 10 | 90 | 2.0 | 20.70 | 15.60 | 6.390E+01 | 4.713E+01 | 4.367E+01 | 3.497E+01 | 3.089E+01 |
| Ex. 12 | 10 | 90 | 2.0 | 20.50 | 15.45 | 5.890E+01 | 4.412E+01 | 4.067E+01 | 3.366E+01 | 2.854E+01 |
| Ex. 13 | 10 | 90 | | 20.20 | 15.22 | 7.535E+01 | 5.456E+01 | 4.887E+01 | 4.197E+01 | 3.631E+01 |
| Ex. 14 | 10 | 90 | | 19.90 | 14.99 | 6.390E+01 | 4.319E+01 | 3.964E+01 | 3.019E+01 | 2.921E+01 |
| Ex. 15 | 10 | 90 | | 18.70 | 16.23 | 6.879E+01 | 4.772E+01 | 4.134E+01 | 3.646E+01 | 3.024E+01 |
| Ex. 16 | 10 | 90 | | 21.40 | 15.78 | 5.490E+01 | 4.014E+01 | 3.746E+01 | 3.139E+01 | 2.639E+01 |
| Ex. 17 | 10 | 90 | | 20.80 | 15.44 | 8.790E+01 | 6.512E+01 | 5.487E+01 | 4.278E+01 | 3.525E+01 |
| Ex. 18 | 10 | 90 | | 21.20 | 14.99 | 7.770E+01 | 6.142E+01 | 5.387E+01 | 4.024E+01 | 3.821E+01 |
| Ex. 19 | 10 | 90 | | 19.50 | 16.12 | 7.160E+01 | 6.212E+01 | 5.147E+.01 | 3.966E+01 | 3.345E+01 |
| Ex. 20 | 10 | 90 | | 21.30 | 14.89 | 3.490E+01 | 2.457E+01 | 1.967E+01 | 1.195E+01 | 4.651E+01 |
| Ex. 21 | 10 | 90 | | 19.90 | 15.20 | 4.485E+01 | 3.279E+01 | 2.667E+01 | 1.833E+01 | 1.065E+01 |
| Ex. 22 | 10 | 90 | | 21.00 | 15.43 | 5.290E+01 | 4.125E+01 | 3.428E+01 | 2.546E+01 | 1.622E+01 |
| Ex. 23 | 10 | 90 | | 22.20 | 9.75 | 6.590E+01 | 4.912E+01 | 4.267E+01 | 3.697E+01 | 3.189E+01 |
| Ex. 24 | 10 | 90 | | 26.40 | 13.71 | 4.190E+01 | 3.116E+01 | 2.670E+01 | 2.463E+01 | 2.393E+01 |
| Comp. | | | 2.0 | 21.00 | 14.37 | 5.590E+03 | 4.712E+03 | 3.867E+03 | 3.167E+03 | 2.769E+03 |
| Ex. 1 | | | | | | | | | | |
| Comp. | | | 4.3 | 22.20 | 19.45 | 4.190E+00 | 3.116E+00 | 2.670E+00 | 2.468E+00 | 2.393E+00 |
| Ex. 2 | | | | | | | | | | |
| Comp. | | | 2.0 | 19.80 | 13.80 | 5.270E+03 | 4.312E+03 | 3.647E+03 | 2.897E+03 | 2.089E+03 |
| Ex. 3 | | | | | | | | | | |
| Comp. | | | 2.0 | 20.60 | 14.13 | 7.490E+03 | 5.812E+03 | 4.167E+03 | 3.997E+03 | 3.289E+03 |
| Ex. 4 | | | | | | | | | | |
| Comp. | | | 0.0 | 21.80 | 8.43 | 6.897E+02 | 4.116E+02 | 3.670E+02 | 2.968E+02 | 2.191E+02 |
| Ex. 5 | | | | | | | | | | |
| Comp. | | | 2.2 | 25.45 | 6.21 | 4.319E+01 | 3.212E+01 | 2.467E+01 | 1.247E+01 | 9.393E+00 |
| Ex. 6 | | | | | | | | | | |

*n-CNT: non-functionalized CNT
**s-CNT: surface-functionalized CNT

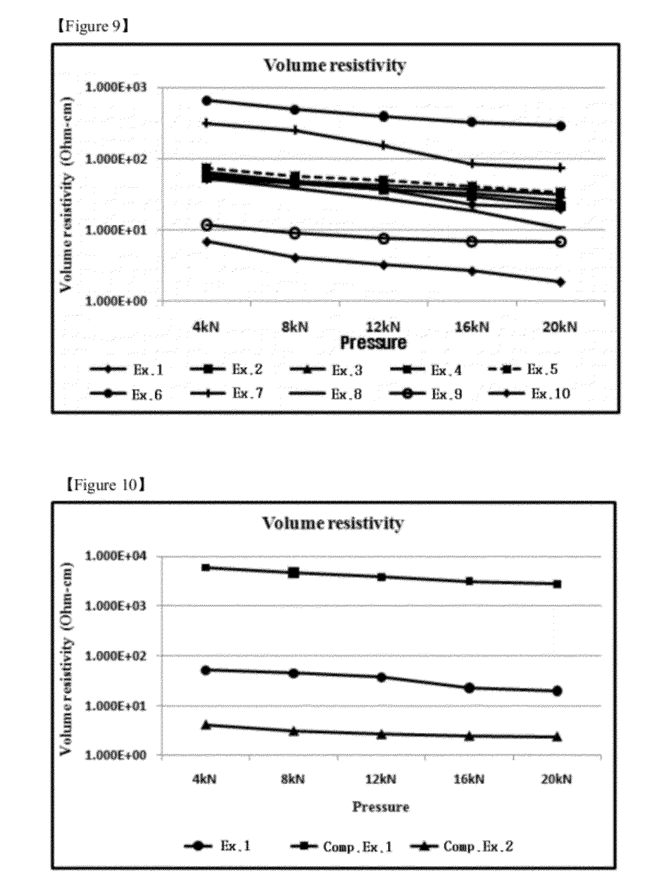

Further, FIG. 9 shows the results obtained from the measurement of powder resistance for Examples 1-10 as presented in Table 4, and FIG. 10 shows the results obtained from the measurement of powder resistance for Example 1 and Comparative Examples 1 and 2. As can be seen from FIGS. 9 and 10, LiFePO₄-carbon nanotube complexes (Examples 1 to 10 and Comparative Example 2) have a significantly lower volume resistance than Comparative Example 1 which adopted only carbon coating.

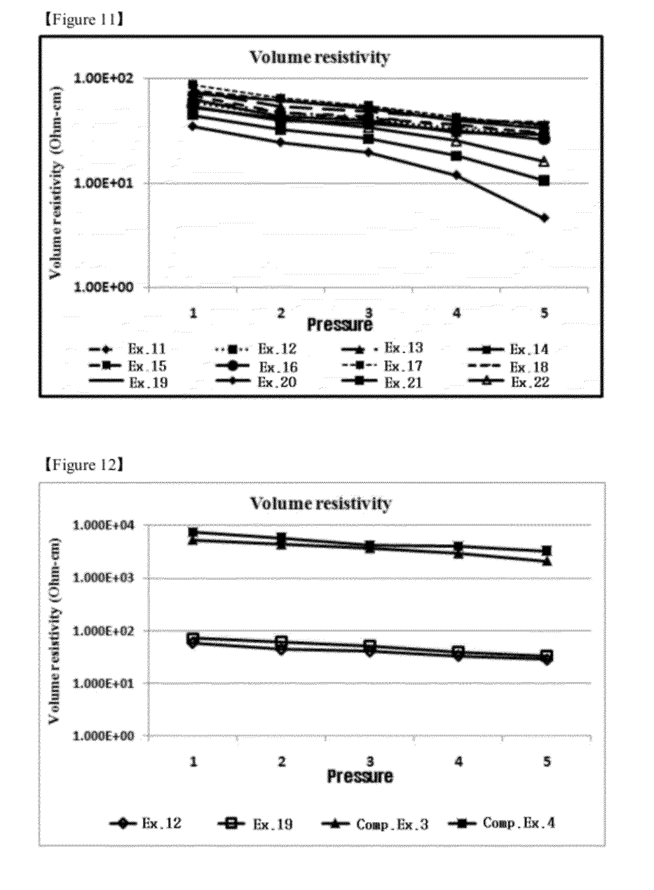

The results obtained from the measurement of the powder resistance of Examples 11-22 as presented in Table 4 are shown in FIG. 11, and the results obtained from the measurement of the powder resistance of Examples 12 and 19 and Comparative Examples 3 and 4 are shown in FIG. 12. As can also be confirmed from FIG. 12, the transition metal phosphate compound-carbon nanotube complexes prepared in Examples 12 and 19 of the present invention have a significantly lower volume resistance than Comparative Examples 3 and 4 which simply adopts a carbon coating.

The results obtained from the measurement of the powder resistance of Example 23 and Comparative Example 5 as presented in Table 4 are shown in FIG. 13. As can be confirmed from FIG. 13, the ternary-system lithium transition metal compound-carbon nanotube complexes prepared in Example 23 of the present invention have a significantly lower volume resistance than Comparative Example 5.

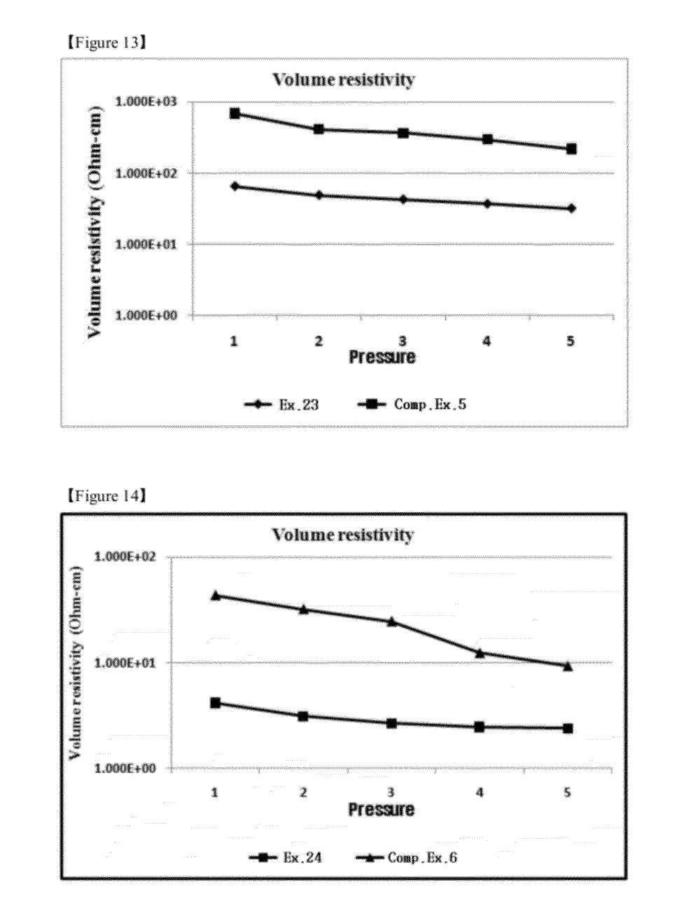

The results obtained from the measurement of the powder resistance of Example 24 and Comparative Example 6 as presented in Table 4 are shown in FIG. 14. As can be confirmed from FIG. 14, the lithium titanate-carbon nanotube complexes having a spinel structure as prepared in Example 24 of the present invention have a significantly lower volume resistance than Comparative Example 6 which simply adopts a carbon coating.

### Fabrication of Electrodes and Coin Cells, and Evaluation of Charge/Discharge Properties

### (1) Products of Examples 1-23 and Comparative Examples 1-5

The final complexes obtained from Examples and Comparative Examples were used as electrode-active materials to fabricate electrodes for lithium secondary batteries, and coin half cells, and then the electrode properties and the electrochemical properties of cells were evaluated and compared.

For the above purposes, 90 parts by weight of the electrode material prepared in one of Examples and Comparative Examples, 5 parts by weight of super-P® (conducting agent), and 5 parts by weight of polyvinylidene fluoride (binder, PVDF) were added to N-methyl pyrrolidinone (NMP), and then mixed in a mortar to prepare a mixture slurry for a cathode. The resulting slurry was applied to one side of aluminum foil, dried and then rolled through a pressing process to produce a cathode plate.

Said cathode plate was punched into a circular specimen having a diameter of 1.2 cm and used as the cathode, and a lithium metal film was used as the anode. 1 mol of LiPF₆ was dissolved in a solvent mixture of ethylene carbonate (EC):ethyl methyl carbonate (EMC) in a mixing ratio of 1:2 by volume to be used as the electrolyte, and a Celgard 2400 film was used as the separator membrane to prepare a lithium secondary battery.

(a) Charge/Discharge Properties of Lithium Secondary Batteries Fabricated by Using the Final Complexes Prepared in Examples 1 to 10 and Comparative Examples 1 and 2

The charge/discharge capacities depending on C-rates (0.1C, 0.2C, 1.0C, 5.0C and 10.0C) were measured in the range of 2.0 to 4.1V by a Maccor series 4000 battery tester, and the results are shown in the following Table 5.

TABLE 5

| | Electrode | | | | | | | | | | | |
|---|---|---|---|---|---|---|---|---|---|---|---|---|
| | Electrode | Surface | Specific Charge/Discharge Capacity (mAh/g) | | | | | | | | | |
| | Density | Resistivity | 0.1 C/0.1 C | | 0.2 C/0.2 C | | 0.2 C/1.0 C | | 0.2 C/5.0 C | | 1.0 C/10.0 C | |
| Class | (g/cm³) | (Ω · cm) | C* | D** | C* | D** | C* | D** | C* | D** | C* | D** |
| Ex. 1 | 2.02 | 158 | 157.1 | 156.4 | 157.2 | 154.3 | 150.6 | 144.2 | 144.8 | 121.8 | 123.9 | 108.6 |
| Ex. 2 | 2.04 | 162 | 157.4 | 156.3 | 156.5 | 154.5 | 151.6 | 145.6 | 143.5 | 120.9 | 124.9 | 110.8 |
| Ex. 3 | 2.11 | 148 | 156.5 | 156.1 | 156.4 | 155.7 | 152.3 | 146.8 | 142.5 | 123.6 | 125.4 | 112.8 |
| Ex. 4 | 2.08 | 152 | 156.8 | 156.3 | 155.7 | 154.8 | 153.8 | 148.4 | 145.6 | 127.8 | 131.2 | 115.9 |
| Ex. 5 | 2.13 | 143 | 154.6 | 154.3 | 154.1 | 154.0 | 153.8 | 149.8 | 147.2 | 135.8 | 132.7 | 122.6 |
| Ex. 6 | 2.15 | 186 | 143.2 | 141.3 | 140.6 | 139.8 | 135.4 | 130.2 | 130.3 | 110.6 | 111.5 | 95.6 |
| Ex. 7 | 2.09 | 176 | 148.6 | 147.8 | 145.8 | 144.8 | 140.5 | 138.7 | 134.1 | 115.8 | 118.7 | 99.8 |
| Ex. 8 | 2.03 | 124 | 157.1 | 156.8 | 156.9 | 157.8 | 150.4 | 146.5 | 145.6 | 128.3 | 135.4 | 116.4 |
| Ex. 9 | 1.98 | 110 | 150.3 | 150.2 | 149.8 | 148.7 | 145.6 | 144.2 | 140.5 | 124.3 | 122.4 | 115.2 |
| Ex. 10 | 1.95 | 89 | 148.5 | 147.9 | 147.8 | 146.9 | 141.2 | 140.8 | 139.5 | 121.3 | 118.7 | 110.5 |
| Comp. | 2.12 | 689 | 129.7 | 132.4 | 131.8 | 127.8 | 119.8 | 111.9 | 88.4 | 86.7 | 88.6 | 74.5 |
| Ex. 1 | | | | | | | | | | | | |
| Comp. | 2.13 | 98 | 133.9 | 136.6 | 136.0 | 132.0 | 124.2 | 116.2 | 93.2 | 91.4 | 92.6 | 78.5 |
| Ex. 2 | | | | | | | | | | | | |

C*: charge
D**: discharge

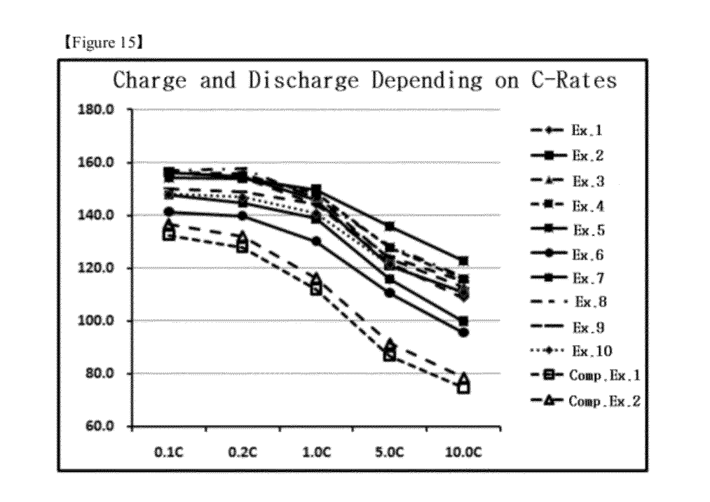

The charge/discharge capacities of Examples 1-10 and Comparative Examples 1 and 2 at each C-rate as shown in Table 5 are depicted as a graph in FIG. 15, from which it can be confirmed that the LiFePO₄-fibrous carbon material complex of Example 1 exhibits remarkably superior charge/discharge properties as compared with Comparative Example 1 prepared by simply coating a fibrous carbon material complex with carbon, and Comparative Example 2 which adopts both a carbon coating and mixing with carbon nanotubes (CNTs). Further, it can also be confirmed that the transition metal phosphate compound-carbon nanotube complexes of Examples 2-10 exhibit superior charge/discharge properties as compared with Comparative Example 1 prepared by simply coating a fibrous carbon material complex with carbon, and Comparative Example 2 which adopts both a carbon coating and mixing with CNTs.

The diffusion coefficient of Li ion was measured for the lithium ion batteries prepared from Example 1 and Comparative Examples 1 and 2, and the results are shown in the following Table 6.

TABLE 6

| | | X: Li₍₁₋ₓ₎FePO₄ | | | | |
|---|---|---|---|---|---|---|
| | | 0.1 | 0.2 | 0.4 | 0.6 | 0.8 |
| Diffusion | Example 1 | 9.00E−10 | 8.00E−09 | 5.00E−08 | 5.00E−08 | 6.80E−08 |
| Coefficient of | Comparative | 5.00E−12 | 1.00E−11 | 8.00E−11 | 8.00E−11 | 9.00E−11 |
| Li ion (S/cm²) | Example 1 | | | | | |
| | Comparative | 6.00E−12 | 9.00E−12 | 6.00E−11 | 6.00E−11 | 8.00E−11 |
| | Example 2 | | | | | |

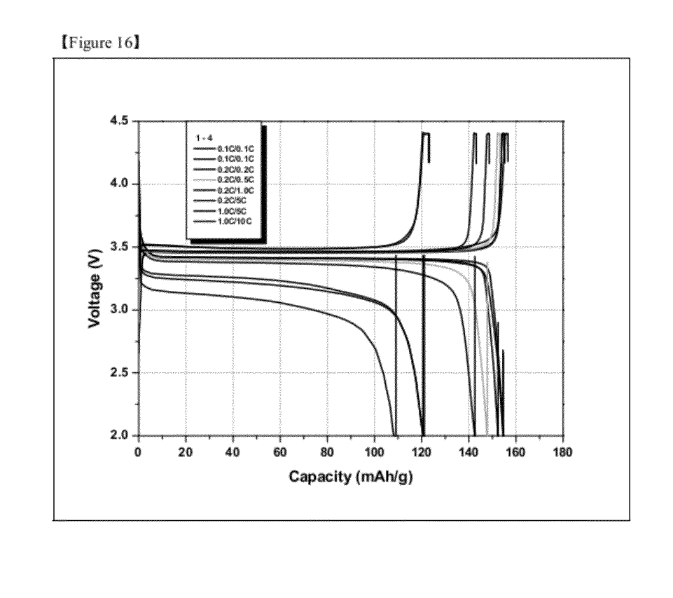

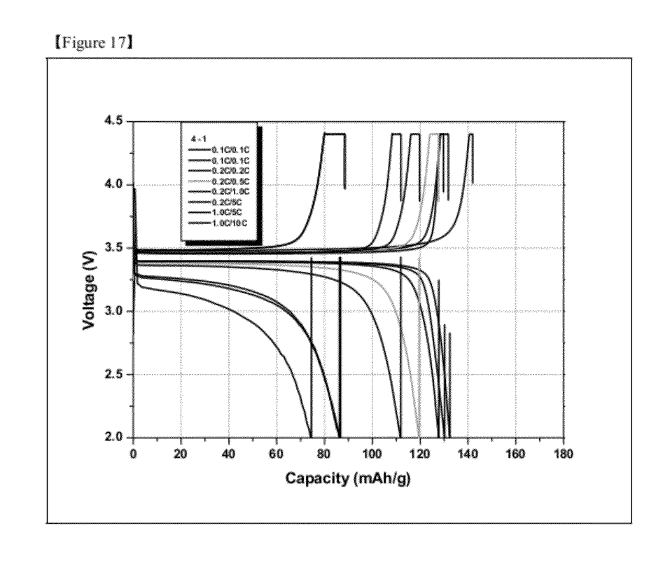

FIGS. 16, 17 and 18 show graphs for charge/discharge properties of lithium secondary batteries produced by using the complexes prepared in Example 1, and Comparative Examples 1 and 2 as cathode-active material.

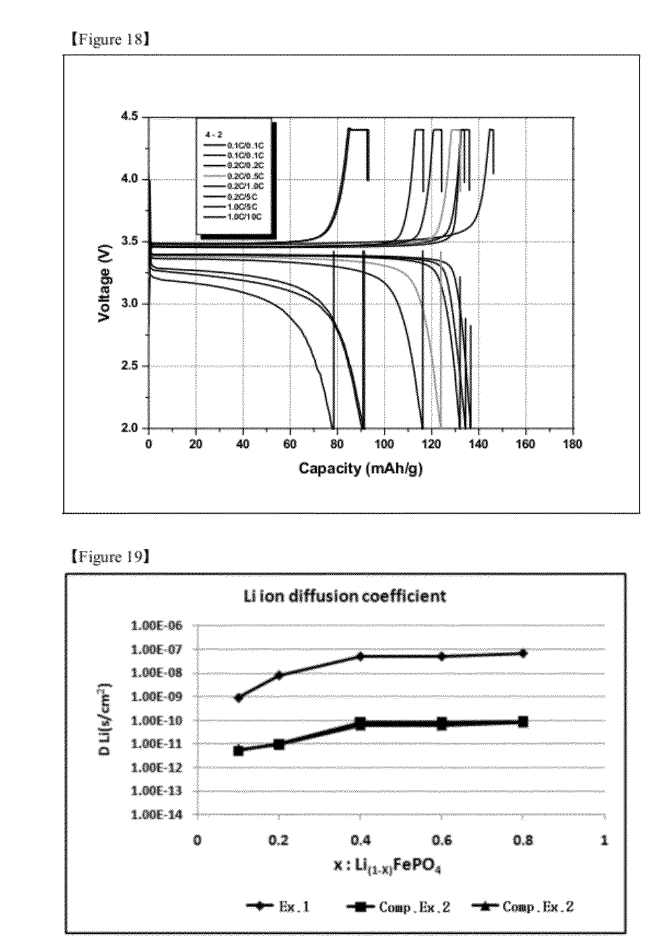

It is confirmed that the discharge capacity and the efficiency at various C-rates of the lithium iron phosphate-carbon nanotube complex prepared in Example 1 (FIG. 16) are remarkably superior to the discharge capacity and the efficiency at various C-rates of the carbon-coated lithium iron phosphate of Example 1 and the mixture of carbon coating and carbon nanotube complex of Comparative Example 2 (FIGS. 17 and 18). Particularly, it is confirmed that in the degree of voltage drop depending on C-rates, the lithium iron phosphate-carbon nanotube complex of Example 1 exhibits the best results.

In the case of Comparative Example 2, its electric conductivity according to electrode resistance is equivalent to that of Example 1 but the diffusion rate of lithium ions is significantly lower than that of Example 1. This suggests that the intercalation and deintercalation of Li ions are suppressed by the carbon coating. FIG. 19 shows graphs of relative lithium ion diffusion coefficients for Example 1, and Comparative Examples 1 and 2.

(b) Charge/Discharge Properties of Lithium Secondary Batteries Fabricated by Using the Final Granular Complexes Prepared in Examples 11-22 and Comparative Examples 3 and 4

Charge/discharge capacities depending on C-rates (0.1C, 0.2C, 1.0C, 5.0C and 10.0C) were measured in the range of 2.0 to 4.1V by Maccor series 4000 battery tester, and the results are shown in the following Table 7.

TABLE 7

| | Electrode | | | | | | | | | | | |
|---|---|---|---|---|---|---|---|---|---|---|---|---|
| | Electrode | Surface | Specific Charge/Discharge Capacity (mAh/g) | | | | | | | | | |
| | Density | Resistivity | 0.1 C/0.1 C | | 0.2 C/0.2 C | | 0.2 C/1.0 C | | 0.2 C/5.0 C | | 1.0 C/10.0 C | |
| Class | (g/cm³) | (Ω · cm) | C* | D** | C* | D** | C* | D** | C* | D** | C* | D** |
| Ex. 11 | 2.04 | 250 | 147.3 | 146.5 | 146.6 | 146.2 | 143.3 | 137.5 | 130.5 | 128.4 | 122.5 | 115.3 |
| Ex. 12 | 2.07 | 244 | 143.2 | 142.8 | 142.9 | 142.5 | 140.8 | 135.4 | 128.7 | 124.1 | 122.5 | 112.1 |
| Ex. 13 | 2.06 | 248 | 149.8 | 148.9 | 147.7 | 146.9 | 143.8 | 142.7 | 140.4 | 126.5 | 125.4 | 110.3 |
| Ex. 14 | 2.07 | 246 | 139.7 | 139.2 | 138.7 | 138.5 | 135.4 | 130.7 | 128.5 | 120.8 | 118.7 | 108.1 |
| Ex. 15 | 2.03 | 254 | 136.7 | 136.4 | 135.5 | 134.8 | 130.8 | 129.7 | 123.1 | 115.4 | 118.4 | 102.3 |
| Ex. 16 | 2.08 | 266 | 146.5 | 146.2 | 146.2 | 145.9 | 142.1 | 140.8 | 131.8 | 125.9 | 124.3 | 112.8 |
| Ex. 17 | 2.09 | 244 | 140.2 | 140.0 | 139.5 | 139.2 | 135.6 | 134.1 | 124.8 | 115.4 | 116.8 | 102.1 |
| Ex. 18 | 2.04 | 245 | 136.4 | 136.2 | 135.8 | 135.1 | 132.4 | 131.2 | 126.4 | 122.1 | 118.2 | 103.4 |
| Ex. 19 | 2.07 | 247 | 141.2 | 140.9 | 140.6 | 140.3 | 138.7 | 136.5 | 130.5 | 129.8 | 124.5 | 116.4 |
| Ex. 20 | 2.09 | 256 | 152.3 | 151.2 | 151.6 | 150.9 | 149.8 | 149.2 | 135.6 | 130.8 | 125.4 | 116.4 |
| Ex. 21 | 2.01 | 247 | 148.2 | 148.1 | 147.5 | 145.8 | 144.6 | 136.4 | 132.1 | 126.5 | 123.5 | 113.2 |
| Comp. | 2.11 | 587 | 140.2 | 140.1 | 139.8 | 138.2 | 135.4 | 125.4 | 115.8 | 108.9 | 102.8 | 85.3 |
| Ex. 3 | | | | | | | | | | | | |
| Comp. | 2.13 | 545 | 135.2 | 134.9 | 134.8 | 134.2 | 129.5 | 128.5 | 116.4 | 98.7 | 98.6 | 75.3 |
| Ex. 4 | | | | | | | | | | | | |

C*: charge
D**: discharge

As can be confirmed from Table 7, the electrodes and lithium secondary batteries made by using the powders of Examples 11 to 22 exhibit lower electrode resistances and far better charge/discharge properties than those prepared from Comparative Examples 3 and 4 which simply adopt a carbon coating.

(c) Charge/Discharge Properties of Lithium Secondary Batteries Produced by Using the Final Products Prepared in Example 23 and Comparative Example 5

Charge/discharge capacities depending on C-rates were measured in the voltage range of 4.5 to 2.0 V by a Maccor series 4000 battery tester, and the results are shown in the following Table 8.

TABLE 8

| | Electrode | | | | | | | | | | | |
|---|---|---|---|---|---|---|---|---|---|---|---|---|
| | Electrode | Surface | Specific Charge/Discharge Capacity (mAh/g) | | | | | | | | | |
| | Density | Resistivity | 0.1 C/0.1 C | | 0.2 C/0.2 C | | 1.0 C/1.0 C | | 5.0 C/5.0 C | | 10.0 C/10.0 C | |
| Class | (g/cm³) | (Ω · cm) | C* | D** | C* | D** | C* | D** | C* | D** | C* | D** |
| Ex. 23 | 2.53 | 128 | 203.8 | 182.7 | 185.0 | 179.8 | 181.3 | 175.2 | 176.4 | 174.1 | 169.4 | 163.2 |
| Comp. | 2.62 | 212 | 199.2 | 173.2 | 175.9 | 171.9 | 173.7 | 168.0 | 169.2 | 168.0 | 161.7 | 152.9 |
| Ex. 5 | | | | | | | | | | | | |

C*: charge
D**: discharge

As can be confirmed from Table 8, the electrode and lithium secondary battery produced by using the powder of Example 23 exhibit a lower electrode resistance and far better charge/discharge properties than those produced from Comparative Example 5 which simply adopts a carbon coating.

### (2) Products of Example 24 and Comparative Example 6

The final complexes obtained by Example 24 and Comparative Example 6 were used to prepare cathodes for lithium secondary batteries.

80 parts by weight of the final complex powder prepared from one of Example 24 and Comparative Example 6, 10 parts by weight of super-P® (conducting agent), and 10 parts by weight of polyvinylidene fluoride (binder, PVDF) were added to N-methylpyrrolidinone (NMP), and then mixed in a mortar to prepare a slurry of a cathode mixture. The resulting slurry was applied to one side of aluminum foil, dried and then rolled through a pressing process to produce a cathode plate.

Said cathode plate was punched into a circular specimen having a diameter of 1.2 cm and used as a cathode, and a lithium metal film was used as an anode. 1 mol of LiPF₆ was dissolved in a solvent mixture of ethylene carbonate (EC):ethyl methyl carbonate (EMC) in a mixing ratio of 1:2 by volume to be used as an electrolyte, and a Celgard 2400 film was used as a separator membrane to prepare a lithium secondary battery.

For the lithium secondary batteries obtained as above, charge/discharge capacities depending on C-rates were measured in the voltage range of 3.0 to 0.5 V by a Maccor series 4000 battery tester, and the results are shown in the following Table 9.

TABLE 9

| | Electrode | | | | | | | | | | | |
|---|---|---|---|---|---|---|---|---|---|---|---|---|
| | Electrode | Surface | Specific Charge/Discharge Capacity (mAh/g) | | | | | | | | | |
| | Density | Resistivity | 0.1 C/0.1 C | | 0.2 C/0.2 C | | 1.0 C/1.0 C | | 5.0 C/5.0 C | | 10.0 C/10.0 C | |
| Class | (g/cm³) | (Ω · cm) | C* | D** | C* | D** | C* | D** | C* | D** | C* | D** |
| Ex. 24 | 2.21 | 88 | 188.1 | 191.1 | 186.2 | 188.7 | 186.2 | 185.2 | 186.5 | 180.2 | 188.7 | 169.1 |
| Comp. | 2.20 | 321 | 176.7 | 180.5 | 177.5 | 177.5 | 174.6 | 171.2 | 164.4 | 135.0 | 138.8 | 104.1 |
| Ex. 6 | | | | | | | | | | | | |

C*: charge
D**: discharge

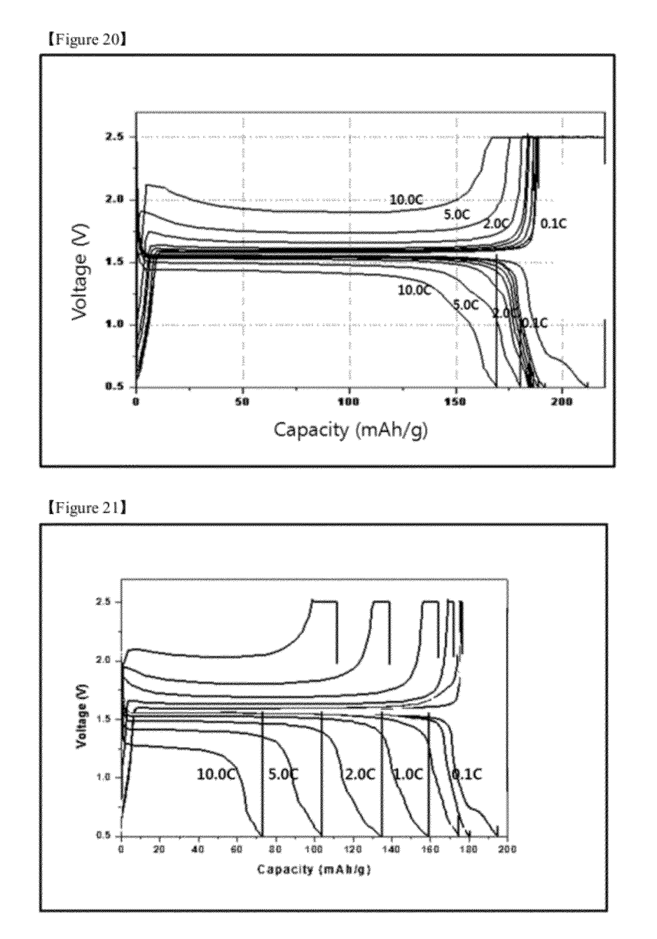

As can be confirmed from Table 9, the electrode and lithium secondary battery produced by using the final complex powder of Example 24 of the present invention exhibit a lower electrode resistance and far better charge/discharge properties than those produced from Comparative Example 6 which simply adopts a carbon coating. FIGS. 20 and 21 are graphs showing the charge/discharge properties depending on C-rates for Example 24 and Comparative Example 6.

### INDUSTRIAL APPLICABILITY

In the present invention, a fibrous carbon material having superior electric conductivity is used to achieve superior electric conductivity as compared with cases where particles of electrode-active materials are coated with carbon or an electrode-active material is used in combination with conventional electric conductive materials.

In the surface region of a complex of the present invention, fibrous carbon materials are present. Different from cases where a carbon material is coated on the surfaces of transition metal compound particles, the fibrous carbon materials of the present invention do not interfere with the intercalation and deintercalation of ions accompanying electrochemical reactions and provide sufficient routes for ion movement, and since they do not disturb the contact of electrode-active materials with the electrolytic solution, they allow the electrode-active materials to sufficiently exhibit their intrinsic electrochemical properties.

In addition, in the surface region of the complex, fibrous carbon materials are relatively densely present. Therefore, when preparing an electrode by applying electrode materials to a current collector and rolling them, adjacent complexes are continuously electrically connected by fibrous carbon materials and greatly increase the electric conductivity of the complexes, thereby remarkably increasing high-rate capability. Further, the electrode-active materials contact the current collector over a large area due to the medium of the fibrous carbon materials, and adhesion strength is increased and the life properties and stability of the electrodes are improved.

If the amount of the fibrous carbon materials present in the surface region of a complex is too small, the external surface region of the complex cannot be sufficiently covered with the carbon materials. Therefore, when external forces such as compression, shearing, etc. are applied to the complex during procedures for preparing an electrode, there may occurs problems in that the complexes collapse, and as a result, primary particles may be scattered. Further, in preparing an electrode, complexes are applied to a current collector in a slurry state. Here, if the amount of fibrous carbon materials present in the surface region is too small, the complex may be dismantled during a dispersion process for making a slurry, and the fibrous carbon materials may form aggregates with one another, thereby making the electrode not uniform overall.

Meanwhile, if the amount of fibrous carbon materials present in the inside of a complex is too small, electrical connection among primary particles by the fibrous carbon materials is insufficient so that the electric conductivity of the complex cannot be sufficiently improved. In addition, when the complex is heat-treated at a high temperature to improve its physical properties during the process for making the complex, the fibrous carbon materials present in the inside of the complex prevent direct contact among primary particles and thus inhibit the aggregation or growth of primary particles. However, such an effect cannot be attained if the amount of fibrous carbon materials is too small.

On the contrary, if the fibrous conductive materials are present in excess, the amount of transition metal compounds as a constituent of the complex is reduced, and then the electrode produced by utilizing the complexes have problems in that they have a low electrode density and ultimately have a low battery capacity, and, further, an excessive amount of carbon materials is required, which increases production costs.

The complexes of the present invention are useful as electrode materials for secondary batteries, memory devices, capacitors and other electrochemical elements, and particularly, are suitable for cathode-active materials of secondary batteries.

1. A complex comprising an aggregate of primary particles of an electrode-active transition metal compound, and a fibrous carbon material, wherein said fibrous carbon material is present more densely in the surface region of the aggregate than in the inside of the aggregate.

2. The complex of claim 1, wherein said fibrous carbon material has an average diameter of 0.5 to 200 nm and an average aspect ratio of length to diameter not less than 10.

3. The complex of claim 1, wherein said fibrous carbon material is a carbon fibers or carbon nanotubes.

4. The complex of claim 1, wherein all or part of said primary particles are electrically connected by said fibrous carbon material, and said fibrous carbon material is present in the surface region of the aggregate of said primary particles in the form of a web.

5. The complex of claim 1, comprising said transition metal compound and said fibrous carbon material in a ratio of 99.9:0.1 to 80:20 by weight.

6. (canceled)

7. The complex of claim 1, wherein said fibrous carbon material comprises a non-functionalized fibrous carbon material and a surface-functionalized fibrous carbon material, in which said non-functionalized fibrous carbon material and said surface-functionalized fibrous carbon material are present in a ratio of 1:99 to 20:80 by weight.

8.-9. (canceled)

10. The complex of claim 1, wherein said transition metal compound is one or more selected from the group consisting of LiCoO₂; LiMnO₂; LiMn₂O₄; Li₄Ti₅O₁₂; Li(Ni_{1-x-y}CoₓAl_{y})O₂(x+y≦1, 0.01≦x≦0.99, 0.01≦y≦0.99); Li(Ni_{1-x-y}MnₓCo_{y})O₂(x+y≦1, 0.01≦x≦0.99, 0.01≦y≦0.99); and Li_{2-z}(Fe_{1-x-y}M¹ₓM²_{y})_{z}O₂(x+y≦1, 0.01≦x≦0.99, 0.01≦y≦0.99, 0<z<1, and each of M¹ and M² is Ti, Ni, Zn, or Mn).

11. The complex of claim 1, wherein said transition metal compound is represented by the following chemical formula 1:
Li₁₋ₓM(PO₄)_{1-y} (1)
wherein 0≦x≦0.15, 0≦y≦0.1, and M is represented by the following chemical formula 2:
M^{A}ₐM^{B}_{b}M^{T}ₜFe_{1-(a+b+t)} (2)
wherein M^{A} is one or more elements selected from the group consisting of the Group 2 elements; M^{B} is one or more elements selected from the group consisting of the Group 13 elements; M^{T} is one or more elements selected from the group consisting of Sc, Ti, V, Cr, Mn, Co, Ni, Cu, Zn, Y, Zr, Nb, and Mo; 0≦a≦1; 0≦b≦0.575; 0≦t≦1; 0≦(a+b)<1; and 0≦(a+b+c)≦1.

12. The complex of claim 1, wherein said transition metal compound is represented by the following chemical formula 3:
LiMPO₄ (3)
wherein M is one element or the combination of two or more elements selected from the group consisting of Fe, Mn, Ni, Co, Ni, Cu, Zn, Y, Zr, Nb and Mo.

13. The complex of claim 1, wherein said complex has an average particle size of 1 to 200 μm.

14. An electrode comprising the complex of claim 1.

15. A secondary battery comprising the electrode of claim 14.

16. A method for preparing a complex of claim 1, comprising:
preparing a mixture wherein a non-functionalized fibrous carbon material, a surface-functionalized fibrous carbon material and transition metal compound particles are dispersed and wherein the weight of the surface-functionalized fibrous carbon material is greater than that of the non-functionalized fibrous carbon material; and
drying and granulating said mixture.

17. The method of claim 16, wherein said mixture comprises said non-functionalized fibrous carbon material and said surface-functionalized fibrous carbon material in a ratio of 1:99 to 20:80 by weight.

18. The method of claim 16, wherein said mixture comprises 10 to 500 parts by weight of a dispersant with respect to 100 parts by weight of the whole fibrous carbon material.

19. The method of claim 16, wherein said transition metal compound and said fibrous carbon material are present in a ratio of 99.9:0.1 to 80:20 by weight.

20. The method of claim 16, wherein said fibrous carbon material is carbon fibers or carbon nanotubes and has an average diameter of 0.5 to 200 nm and an average aspect ratio of length to diameter not less than 10.

21. The method of claim 16, wherein said transition metal compound is represented by the following formula 1:
Li₁₋ₓM(PO₄)_{1-y} (1)
wherein 0≦x≦0.15, 0≦y≦0.1, and M is represented by the following formula 2:
M^{A}ₐM^{B}_{b}M^{T}ₜFe_{1-(a+b+t)} (2)
wherein M^{A} is one or more elements selected from the group consisting of the Group 2 elements, M^{B} is one or more elements selected from the group consisting of the Group 13 elements; M^{T} is one or more elements selected from the group consisting of Sc, Ti, V, Cr, Mn, Co, Ni, Cu, Zn, Y, Zr, Nb, and Mo; 0≦a≦1; 0≦b<0.575; 0≦t≦1; 0≦(a+b)<1; and 0≦(a+b+c)≦1.

22. The method of claim 16, wherein said surface-functionalized fibrous carbon material contains oxygen, nitrogen or hydrogen at 0.05 to 5% by weight.

23. The method of claim 16, wherein said surface-functionalized carbon material is a surface-oxidized fibrous carbon material.

24. The method of claim 16, wherein said mixture is prepared by preparing a dispersion of said non-functionalized fibrous carbon material and said surface-functionalized fibrous carbon material dispersed in a dispersing medium, and mixing said dispersion with said transition metal compound.

25. The method of claim 24, wherein said dispersing medium is one or more selected from the group consisting of water, alcohol, ketone, amine, ester, amide, alkyl halogen, ether, and furan.
